(19) United States
(12) Patent Application Publication
(10) Pub. No.: US 2026/0193479 A1
(43) Pub. Date: Jul. 9, 2026

(54) A COATING KIT AND USE OF SAID COATING KIT

(71) Applicant: GOVI NV, Drongen (BE)

(72) Inventors: Jan COCQUYT, Drongen (BE); Mathieu BALCAEN, Drongen (BE); Julie CLARYSSE, Drongen (BE)

(21) Appl. No.: 19/135,488

(22) PCT Filed: Dec. 6, 2023
(86) PCT No.: PCT/EP2023/084551

§ 371 Date: Jun. 4, 2025

(30) Foreign Application Priority Data
Dec. 6, 2022 (BE) BE2022/5994

(51) Int. Cl. C09D 7/63; B65D 65/42; C08K 5/101; C09D 7/20; C09D 7/45; D21H 19/12

(52) U.S. Cl. CPC C09D 7/63; B65D 65/42; C09D 7/20; C09D 7/45; D21H 19/12; C08K 5/101

(57) ABSTRACT

The current invention relates to a coating kit, comprising an aqueous linear ester dispersion, comprising one or more linear esters in water, wherein said linear esters are chosen from the list of: linear monoesters according to formula (I), linear di-esters according to formula (II), linear di-esters according to formula (III), or mixtures thereof and one or more binders, wherein said binder chosen from the list of waterborne polymeric binder dispersion, water soluble polymeric binder, waterborne reactive binder or a mixture thereof. The invention further relates to the use thereof. In another aspect the invention provides a coating composition and the use thereof.

### FIELD OF THE INVENTION

The present invention relates to a coating kit. In a further aspect the invention relates to a coating composition and use of said kit or said composition.

### BACKGROUND

There is a strong demand in the market for biobased alternatives for paraffin wax dispersions which are used to impart water repelling characteristics to wood panels and cellulose sheet products. When paraffin wax dispersions are used as a coating material, there is a big risk of migration of MOSH/MOAH (Mineral Oil Saturated Hydrocarbons/Mineral Oil Aromatic Hydrocarbons) substances into the packed food product.

Today, dispersions of hydrogenated vegetable oils are regularly used as an alternative for paraffin waxes. However, these dispersions do not provide a good barrier to water vapor when used as an additive in paper coatings. Furthermore, vegetable oil-based waxes still are not widely used on a commercial scale, because of their limitations in delivering desired physical properties, e.g., they are either too hard and brittle or too soft and greasy and have poor melting and recrystallization profiles.

Kangzi et al. studied the rheological characteristics of ethylene and propylene glycol mono- and di-esters of stearic acid. However, only water repellency, and not water vapor transmission rates, was investigated.

Natural waxes, such as beeswax, candelila wax and carnauba wax give barrier properties. However, these waxes are expensive and generally have a dark color. Furthermore, these waxes still contain al lot of free fatty acids and very long chained monoesters. In addition, natural waxes have a limited availability. These can be generally considered as niche rather than bulk products.

Therefore, there remains a strong need to obtain various biodegradable wax materials that can be derived from renewable raw materials, with a high melting point, high cohesiveness, high hardness, high clarity, good water repellency, low coefficient of surface friction, and low water vapor transmission rate suitable to replace petroleum paraffin. The present invention is directed to fulfilling this need in the art.

The present invention aims to resolve at least some of the problems and disadvantages mentioned above.

### SUMMARY OF THE INVENTION

The present invention and embodiments thereof serve to provide a solution to one or more of above-mentioned disadvantages. To this end, the present invention relates to a coating kit according to claim 1. Preferred embodiments of the coating kit are shown in any of the claims 2 to 9. In a second aspect, the present invention relates to a coating composition according to claim 10. Preferred embodiments of the coating kit are shown in any of the claims 11 and 12. In a third aspect, the present invention relates to a use according to claims 13 and 14.

Dispersions of fatty acid based biowax (mono)-esters can be used as an answer to the demand in the market for biobased alternatives for paraffin wax dispersions which are used to impart water repelling characteristics to wood panels and cellulose sheet products. The recyclability of paper, coated with this type of coating kit or coating composition, is improved as compared to paper coated with a paraffin wax. In particular the biodegradability is significantly improved compared to paraffin-based coatings. Moreover, there is no risk of migration of MOSH/MOAH (Mineral Oil Saturated Hydrocarbons/Mineral Oil Aromatic Hydrocarbons) substances into the packed food product, which can occur when paraffin waxes were used as a coating material.

The coating kit and the coating composition according to the invention are advantageous due to the ester bond which can be hydrolyzed resulting in better washability of the coating.

The coating kit and the coating composition according to the invention have a high flexibility, as stability of each constituent of the kit is high and dilution in terms of the intended application is very easily achieved.

The coating kit and the coating composition according to the invention are easily pumpable and thus easier in use.

The coating kit and the coating composition according to the present invention are especially advantageous for closed paper packaging, because in paper food packaging it is generally necessary that next to the barrier to liquid water, the barrier to water vapor is also lowered by the coating. The inventors unexpectedly found that a very big decrease in water vapor transmission rate was achieved in paper food packaging coated with a coating kit according to the invention, as opposed to coatings comprising branched ester structures, such as triglyceride esters.

Surprisingly it has emerged that cellulose sheets coated with a coating kit or coating composition according to the invention exhibit high resistance to fats and/or oils and/or moisture and at the same time can be produced wholly or predominantly from renewable raw materials.

### DETAILED DESCRIPTION OF THE INVENTION

The present invention concerns a coating kit and a coating composition.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:
“Hydrocarbon radical” or “hydrocarbon chain” typically consists only of carbon and hydrogen. The term used herein includes aliphatic hydrocarbon radicals (e.g., alkane, alkene or alkyne) may be of linear (unbranched), branched, or cyclic hydrocarbon structure, and saturated or unsaturated. Branched hydrocarbon means that one or more lower alkyl groups such as methyl, ethyl, or propyl are attached to a linear hydrocarbon chain.

The term “alkyl” refers to an aliphatic hydrocarbon group which may be a linear (unbranched), branched, or cyclic hydrocarbon structure or combination thereof. Representative alkyl groups are those having 28 or fewer carbon atoms. Branched alkyl means that one or more alkyl groups such as methyl, ethyl, or propyl are attached to a linear alkyl chain.

The statement that alkyl is intended to include linear, branched, or cyclic hydrocarbon structures and combinations thereof means that an “alkyl” group also includes the combinations of linear and cyclic structural elements.

The term “wax ester”, as used herein, refers to an ester of a fatty acid and a fatty alcohol. “Wax esters” are formed by combining one fatty acid with one fatty alcohol. The ester thus has a single ester group, and both hydrocarbon chains on said ester group are linear, saturated or unsaturated hydrocarbon chains. These hydrocarbon chains have a carbon count between 4 and 50, typically 4 to 30, most commonly between 12 and 24.

The term “fatty acid”, as used herein, refers to a carboxylic acid which bears a hydrocarbon radical. The hydrocarbon radical has been described above and can have from about 4 to 50 carbon atoms in length. Typical fatty acids have 4 to 30 carbon atoms, 4 to 28 carbon atoms, 8 to 26 carbon atoms, 8 to 24 carbon atoms, 12 to 24 carbon atoms, or 12 to 18 carbon atoms. They may be of a natural or synthetic origin. Fatty acids can be saturated, unsaturated, or polyunsaturated. When they are unsaturated, they may contain one or more, for example two, three or more, double bonds.

The term “fatty alcohol”, as used herein, refers to an aliphatic primary alcohol. Typical fatty alcohols have 4 to 30 carbon atoms, 4 to 28 carbon atoms, 8 to 26 carbon atoms, 8 to 24 carbon atoms, 12 to 24 carbon atoms, or 12 to 18 carbon atoms. They may be of a natural or synthetic origin. Fatty alcohols can be saturated, unsaturated, or polyunsaturated. When they are unsaturated, they may contain one or more, for example two, three or more, double bonds.

The compounds described herein may contain one or more asymmetric centers and may thus give rise to enantiomers, diastereomers, and other stereoisomeric forms.

Each chiral center may be defined, in terms of absolute stereochemistry, as (R)- or (S)-. The present invention is meant to include all such possible isomers, as well as mixtures thereof, including racemic and optically pure forms. Optically active (R)- and (S)-, (−)- and (+)-, or (D)- and (L)-isomers may be prepared using chiral synthons or chiral reagents or resolved using conventional techniques. When the compounds described herein contain olefinic double bonds or other centers of geometric asymmetry, and unless specified otherwise, it is intended that the compounds include both E and Z geometric isomers. Likewise, all tautomeric forms are also intended to be included. The configuration of any carbon-carbon double bond appearing herein is selected for convenience only and is not intended to designate a particular configuration. Thus, a carbon-carbon double bond depicted arbitrarily herein as trans may be Z, E, or a mixture of the two in any proportion.

The term “water vapor transmission rate” and “WVTR” as used herein are synonyms and refer to the steady state rate at which water vapor permeates through a film at specified conditions of temperature and relative humidity, for example @38° C. and 90% relative humidity. Values are expressed in g/m2/24 h in metric (or SI) units. WVTR is the standard measurement by which films are compared for their ability to resist moisture transmission, with lower values indicating better moisture protection.

Viscosity as used herein is preferably measured in accordance with ISO 2555:2018.

Particle size distribution, including D50 and other metrics thereof, are preferably measured with laser diffraction, preferably in accordance with ISO13320:2020.

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the 25 specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g., component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints Ies all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention provides a coating kit. In a preferred embodiment of the invention, the coating kit is suitable for coating cellulose surfaces, preferably paper, cardboard, or wood. In an even more preferred embodiment of the invention, the coating kit is suitable for coating cellulose surfaces in food packaging.

In a preferred embodiment of the invention, the coating kit comprises an aqueous ester dispersion and one or more binders, wherein said binder is chosen from the list of: waterborne polymeric binder dispersion, water soluble polymeric binder, waterborne reactive binder or a mixture thereof. More preferably said binder being a polymer in water dispersion.

In a particularly preferred embodiment of the invention, the coating kit comprises an aqueous linear ester dispersion. Said aqueous linear ester dispersion comprising one or more linear esters in water.

Advantageously, provision of a coating kit of two separate aqueous constituents allows for easy formulation of the end coating. The amount of ester can be varied based upon the coating requirements.

Preferably, said linear esters are chosen from the list of: linear monoesters, linear di-esters, or mixtures thereof.

In a preferred embodiment said linear monoesters are according to the formula (I):

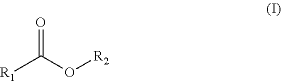

wherein R2 is chosen from C2-C36 hydrocarbon chains, more preferably C2-C24 hydrocarbon chains, preferably linear C2-C24 hydrocarbon chains, more preferably C2-C24 linear alkyl and wherein R1 is, independently from R2, chosen from C1-C35 hydrocarbon chains, more preferably C1-C23 hydrocarbon chains, preferably linear C1-C23 hydrocarbon chains, more preferably C1-C23 linear alkyl. In a most preferred embodiment of the invention, the linear monoesters are linear wax esters.

In another preferred embodiment, aqueous linear ester dispersion comprises linear monoesters according to formula (I), wherein R2 is chosen from C16-C36 linear hydrocarbon chains, and R1 is independently from R2, chosen from C15-C35 linear alkyl. In a further preferred embodiment, R2 is chosen from 16 to 24 linear hydrocarbon chains, and R1 is independently from R2, chosen from C15-C23 linear alkyl. The preferred lower range is optimized for room and lower temperatures, where it results in a good balance between dispersion properties including stability and processability and barrier properties of the resulting coating, particularly with respect to water and water vapor. In another further preferred embodiment, R2 is chosen from 24 to 36 linear hydrocarbon chains, and R1 is independently from R2, chosen from C23-C35 linear alkyl. More preferably, R2 is chosen from 30 to 36 linear hydrocarbon chains, and R1 is independently from R2, chosen from C29-C35 linear alkyl.

In a further preferred embodiment, the aqueous linear ester dispersion comprises:
Linear monoesters according to formula (I), wherein R2 is chosen from 16 to 23 linear hydrocarbon chains, and R1 is independently from R2, chosen from C15-C22 linear alkyl; in an amount of 10 to 75 wt. %, more preferably 10 to 50 wt. %, more preferably 10 to 30 wt. % relative to the total amount of linear esters; and
Linear monoesters according to formula (I), wherein R2 is chosen from 24 to 36 linear hydrocarbon chains, and R1 is independently from R2, chosen from C23-C35 linear alkyl; in an amount of 25 to 90 wt. %, more preferably 50 to 90 wt. %, more preferably 70 to 90 wt. % relative to the total amount of linear esters.

The combination of short and longer chain monoesters improves the stability of the resulting dispersion. It improves the temperature resistance of the resulting coating, resulting in a coating with good water and water vapor barrier properties at both room temperature and elevated temperatures.

The higher chain length esters perform better in high-temperature applications and processes. It is also desirable when the coating is applied at a high temperature, or the coating after application is heated for a period of time. The resulting coating not only has better temperature resistance, it also has better barrier properties for water and water vapor at elevated temperatures. This is particularly important as the water vapor transmission tends to increase significantly with temperature. As a result, these type of coatings are particularly desirable for storing hot perishables, such as freshly baked goods.

R1 is a saturated or unsaturated linear hydrocarbon chain (“fatty hydrocarbon chain”), more preferably an alkyl, most preferably a linear alkyl with 1-23, preferably 3-23, more preferably 5-23, more preferably 7-23, more preferably 9-21, more preferably 11-19, more preferably 11-17 carbon atoms. The applicant notes that fatty hydrocarbon chains typically have an even number of carbon atoms; but R1 has an additional carbon from the carboxylic functional group according to formula I.

In a preferred embodiment, R2 is a saturated or unsaturated linear hydrocarbon chain (fatty hydrocarbon chain), more preferably an alkyl, most preferably a linear alkyl with 2-24, preferably 4-24, more preferably 6-24, more preferably 8-24, more preferably 10-22, more preferably 12-20, more preferably 12-18 carbon atoms.

In a most preferred embodiment of the invention, the linear monoesters are linear wax esters. In the most preferred embodiment, the “alkyl” groups as referred to in formulas I, II and III are linear and fully saturated.

Examples of saturated fatty acids are listed below:

| Common Name | Lipid Number |
|---|---|
| Propionic acid | C3:0 |
| Butyric acid | C4:0 |
| Valeric acid | C5:0 |
| Caproic acid | C6:0 |
| Enanthic acid | C7:0 |
| Caprylic acid | C8:0 |
| Pelargonic acid | C9:0 |
| Capric acid | C10:0 |
| Undecylic acid | C11:0 |
| Lauric acid | C12:0 |
| Tridecylic acid | C13:0 |
| Myristic acid | C14:0 |
| Pentadecylic acid | C15:0 |
| Palmitic acid | C16:0 |
| Margaric acid | C17:0 |
| Stearic acid | C18:0 |
| Nonadecylic acid | C19:0 |
| Arachidic acid | C20:0 |
| Heneicosylic acid | C21:0 |
| Behenic acid | C22:0 |
| Tricosylic acid | C23:0 |
| Lignoceric acid | C24:0 |
| Pentacosylic acid | C25:0 |
| Cerotic acid | C26:0 |
| Carboceric acid | C27:0 |
| Montanic acid | C28:0 |
| Nonacosylic acid | C29:0 |
| Melissic acid | C30:0 |
| Hentriacontylic acid | C31:0 |
| Lacceroic acid | C32:0 |
| Psyllic acid | C33:0 |
| Geddic acid | C34:0 |
| Ceroplastic acid | C35:0 |
| Hexatriacontylic acid | C36:0 |
| Heptatriacontylic acid | C37:0 |
| Octatriacontylic acid | C38:0 |
| Nonatriacontylic acid | C39:0 |
| Tetracontylic acid | C40:0 |

In another preferred embodiment, the “hydrocarbon chains” as referred to in formulas I, II and III may be mono or poly unsaturated, linear hydrocarbon chains. These unsaturated fatty hydrocarbon chains may be replaced with their equal chain length alkyl equivalents as described herein. The skilled person understands that when fatty acids and/or fatty alcohols and/or linear wax esters are produced from nature-derived sources, mono or poly unsaturated chains can occur when the materials are not subjected to a hydrogenation step. Hydrogenation tends to saturate these unsaturated chains.

An amount of unsaturated hydrocarbon chains is beneficial to reduce the crystallinity of the wax, improve emulsification thereof and improve the homogeneity of the obtained coating.

Examples of unsaturated fatty acids, suitable to be esterified and used in accordance with the present invention, are listed below:

| Common name | Lipid number | Common name | Lipid number |
|---|---|---|---|
| Crotonic acid | C4:1 | Eleostearic acid | C18:3 |
| Myristoleic | C14:1 | Mead acid | C20:3 |
| Palmitoleic acid | C16:1 | Dihomo-y-linolenic acid | C20:3 |
| Sapienic acid | C16:1 | Eicosatrienoic acid | C20:3 |
| Oleic acid | C18:1 | Stearidonic acid | C18:4 |
| Elaidic acid | C18:1 | Arachidonic acid | C20:4 |
| Vaccenic acid | C18:1 | Docosatetraenoic acid | C22:4 |
| Gadoleic acid | C20:1 | Eicosatetraenoic acid | C20:4 |
| Eicosenic acid | C20:1 | Adrenic acid | C22:4 |
| Erucic acid | C22:1 | Bosseopentaenoic acid | C20:5 |
| Nervonic acid | C24:1 | Eicosapentaenoic acid | C20:5 |
| Linoleic acid | C18:2 | Ozubondo acid | C22:5 |
| Linolelaidic acid | C18:2 | Sardine acid | C22:5 |
| Eicosadienoic acid | C20:2 | Tetracosanolpentaenoic | C24:5 |
| Docosadienoic acid | C22:2 | acid | |
| Linolenic acid | C18:3 | Cervonic acid | C22:6 |
| Pinolenic acid | C18:3 | Herring acid | C24:6 |

In a particularly preferred embodiment, said linear esters are chosen from stearyl stearate, cetyl stearate, cetyl palmitate, stearyl palmitate or mixtures thereof.

“Stearyl stearate” as used herein is an ester of a mixture of mainly stearyl alcohol (C18) and cetyl alcohol (C16) and a mixture of mainly stearyl acid (C18) and palmitic acid (C16). It thus has a composition of mainly C32, C34 and C36 esters.

“Cetyl stearate” as used herein is an ester of mainly cetyl alcohol (C16) and mainly stearic acid (C18). “Cetyl palmitate” as used herein is an ester of mainly cetyl alcohol (C16) and mainly palmitic acid (C16).

“Stearyl palmitate” as used herein is an ester of mainly stearyl alcohol (C18) and mainly palmitic acid (C16).

In a further preferred embodiment said linear di-esters are according to the formula (II) or (III):

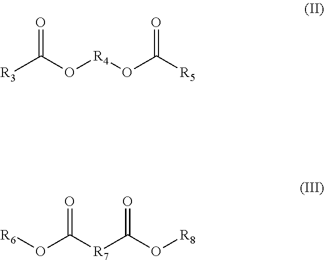

In formula (II) R3 and R5 are independently of one another chosen from a saturated or unsaturated linear hydrocarbon chain (fatty hydrocarbon chain), more preferably an alkyl, most preferably a linear alkyl with 1-23, preferably 3-23, more preferably 5-23, more preferably 7-23, more preferably 9-21, more preferably 11-19, more preferably 11-17 carbon atoms; and
R4 is, independently from R3 and R5, chosen from C2-C24 hydrocarbon chains, preferably linear C2-C24 hydrocarbon chains, more preferably C2-C24 linear alkanediyl. In a preferred embodiment, R4 is a saturated or unsaturated linear hydrocarbon chain (fatty hydrocarbon chain), more preferably an alkanediyl, most preferably a linear alkanediyl with 2-24, preferably 4-24, more preferably 6-24, more preferably 8-24, more preferably 10-22, more preferably 12-20, more preferably 12-18 carbon atoms.

In formula (III) R6 and R8 are independently of one another chosen from C2-C24 hydrocarbon chains, preferably linear C2-C24 hydrocarbon chains, more preferably C2-C24 linear alkyl. In a preferred embodiment, R4 is a saturated or unsaturated linear hydrocarbon chain (fatty hydrocarbon chain), more preferably an alkyl, most preferably a linear alkyl with 2-24, more preferably 4-24, more preferably 6-24, more preferably 8-24, more preferably 10-22, more preferably 12-20, more preferably 12-18 carbon atoms.

R7 is, independently from R6 and R8, chosen from C2-C22 hydrocarbon chains, preferably linear C2-C22 hydrocarbon chains, more preferably C2-C22 linear alkanediyl. In a preferred embodiment, R4 is a saturated or unsaturated linear hydrocarbon chain (fatty hydrocarbon chain), more preferably an alkanediyl, most preferably a linear alkanediyl with 2-22, preferably 4-22, more preferably 6-22, more preferably 8-20, more preferably 10-18, more preferably 10-16 carbon atoms.

The inventors have unexpectedly observed that a coating kit according to the invention results in coatings with significantly decreased water vapor transmission rates, especially on cellulose surfaces, such as paper, wood, cardboard, . . . .

In a particularly preferred embodiment of the invention, the coating kit comprises:
an aqueous linear ester dispersion, comprising one or more linear esters in water, wherein said linear esters are chosen from the list of: linear monoesters according to formula (I), linear di-esters according to formula (II), linear di-esters according to formula (III), or mixtures thereof, wherein
   R1 is chosen from linear C3 to C23 alkyl
   R2 is independently chosen from linear C4-C24 alkyl, preferably linear C12-18 alkyl, and
wherein
   R3 and R5 are independently of one another chosen from linear C3-C23 alkyl, preferably linear 11-17 alkyl,
   R4 is chosen from linear C4-C24 alkanediyl,
and wherein
   R6 and R8 are independently of one another chosen from linear C4-C24 alkyl, preferably linear C12-18 alkyl,
   R7 is chosen from linear C2-C22 alkanediyl,
   and
one or more binders, wherein said binder is chosen from the list of: waterborne polymeric binder dispersion, water soluble polymeric binder, waterborne reactive binder or a mixture thereof.

In a first preferred embodiment of the invention, the linear esters are linear monoesters according to formula (I).

In a second preferred embodiment of the invention, the linear esters are linear di-esters according to formula (II) or (III). In one preferred embodiment, the linear esters are linear di-esters according to formula (II). In another preferred embodiment of the invention, the linear esters are linear di-esters according to formula (III).

In a preferred embodiment of the invention, the ester dispersion has a dry matter content of at least 20% by weight, preferably of at least 25% by weight, more preferably of at least 30% by weight, and even more preferably of at least 35% by weight.

In a preferred embodiment of the invention, the ester dispersion has a dry matter content between 20 and 90% by weight, preferably between 25 and 80% by weight, more preferably between 30 and 70% by weight, and even more preferably between 35 and 60% by weight, more preferably of at least 40% by weight, more preferably of at least 45% by weight, more preferably of at least 50% by weight, more preferably of at least 55% by weight, more preferably of at least 60% by weight. In a preferred embodiment of the invention, the ester dispersion has a dry matter content between 20 and 90% by weight, preferably between 25 and 80% by weight, more preferably between 30 and 70% by weight, more preferably between 35 and 65% by weight, more preferably between 40 and 60% by weight, more preferably between 40 and 55% by weight, most preferably between 45 and 55% by weight. High dry matter content is desirable to reduce operating requirements, reducing the requirement to transport, pump and process high volumes of dispersion. However, higher dry matter content often leads to a reduction in stability, an increase in viscosity and processability. These drawbacks are often partially mitigated by an increase in surfactants and/or surfactant strength, but increasing the amount of surfactant required has its own drawbacks such as higher material requirements and costs, reduced compatibility with other dispersions and dispersions, and difficulty of surfactant removal. For particular uses such as coatings for food packaging, surfactant needs to be food contact grade and low concentrations of surfactant are generally desired.

In a preferred embodiment of the invention, the total amount of linear esters in accordance with formula (I), (II) or (III), more preferably in accordance with formula (I), is at least 10 wt. %, more preferably at least 20 wt. %, more preferably at least 30 wt. %, more preferably at least 40 wt. %, more preferably at least 50 wt. %, more preferably at least 60 wt. %, more preferably at least 70 wt. % relative to the dry matter content of the aqueous linear ester dispersion. The aim is to provide a coating with excellent hydrophobic properties. By having a high linear ester content, the amount of water in the coating kit can be drastically reduced thus improving storage and transport of the coating kit; without reducing the amount of water in the resulting coating. In addition, application and especially drying of the coating is sped up.

In a preferred embodiment, the ester dispersion further comprises a vegetable oil. In a further preferred embodiment, said vegetable oil comprises a mixture of triglycerides, that is to say fatty esters of glycerol. In a further preferred embodiment, said vegetable oil consists essentially of triglycerides. Avoidance of linear hydrocarbons is desirable to avoid MOSH/MOAH related problems. In a further preferred embodiment, the ester dispersion comprises a vegetable oil in an amount of at most 30%, more preferably in an amount of at most 20%, more preferably in an amount of at most 15%, more preferably in an amount of at most 10%, more preferably in an amount of at most 5%, more preferably in an amount of at most 3% by weight with respect to the dry matter content of the ester dispersion. In another preferred embodiment, the ester dispersion comprises a vegetable oil in an amount of at least 0.1%, more preferably at least 0.2%, more preferably at least 0.5%, more preferably at least 1.0%, more preferably at least 1.5%, more preferably at least 2.0%, more preferably at least 2.5%, more preferably at least 3.0%, more preferably at least 5.0%, more preferably at least 10.0% by weight with respect to the dry matter content of the ester dispersion. In a further preferred embodiment, the ester dispersion comprises between 0 and 10% by weight with respect to the dry matter content of the ester dispersion. The inventors found that the addition of a vegetable oil reduces the crystallinity of the linear ester wax, improves the processability of said wax to an dispersion and improves the homogeneity of the resulting coating layer when said linear ester wax dispersion is coated onto a substrate.

In a further preferred embodiment, the vegetable oil is rapeseed oil. In another further preferred embodiment, the ester dispersion comprises a vegetable oil in an amount between 5 and 40% by weight with respect to the dry matter content of the ester dispersion, more preferably between 10 and 40%, more preferably between 10 and 30%, more preferably between 10 and 25%, more preferably between 15 and 25%. In another preferred embodiment, the vegetable oil is comprised between 3.0 and 30% by weight, relative to the dry matter content of the linear ester dispersion.

These ranges were found to be an optimum between improving the processability of the wax to a dispersion and the stability of the dispersion. At these amounts, a vegetable oil was found to have a small positive impact on the barrier properties of the resulting coating. Higher vegetable oil concentrations resulted in a strong reduction of the barrier properties of the obtained coating.

A high dry matter content of the ester dispersion results in an increased water impermeability in the resulting coating, the water impermeability being valid for both liquid as vapor. A high dry matter content is also advantageous because it gives flexibility to the coating kit, as dilution of the dispersion in terms of the intended application is very easily achieved.

In a preferred embodiment, the total amount of said linear esters is at least 15 wt. % relative to the weight of the aqueous linear ester dispersion, more preferably the total amount of said linear esters is at least 20 wt. % relative to the weight of the aqueous linear ester dispersion, more preferably the total amount of said linear esters is at least 25 wt. % relative to the weight of the aqueous linear ester dispersion, more preferably the total amount of said linear esters is at least 30 wt. % relative to the weight of the aqueous linear ester dispersion, more preferably the total amount of said linear esters is at least 35 wt. % relative to the weight of the aqueous linear ester dispersion, more preferably the total amount of said linear esters is at least 40 wt. % relative to the weight of the aqueous linear ester dispersion, more preferably the total amount of said linear esters is at least 45 wt. % relative to the weight of the aqueous linear ester dispersion. In a preferred embodiment, the total amount of said linear esters is at least 50 wt. % relative to the weight of the dry matter content, more preferably the total amount of said linear esters is at least 60 wt. % relative to the weight of the dry matter content, more preferably the total amount of said linear esters is at least 70 wt. % relative to the weight of the dry matter content, more preferably the total amount of said linear esters is at least 75 wt. % relative to the weight of the dry matter content, more preferably the total amount of said linear esters is at least 80 wt. % relative to the weight of the dry matter content, more preferably the total amount of said linear esters is at least 90 wt. % relative to the weight of the dry matter content, more preferably the total amount of said linear esters is at least 95 wt. % relative to the weight of the dry matter content, more preferably the total amount of said linear esters is at least 96 wt. % relative to the weight of the dry matter content, more preferably the total amount of said linear esters is at least 97 wt. % relative to the weight of the dry matter content, more preferably the total amount of said linear esters is at least 98 wt. % relative to the weight of the dry matter content, more preferably the total amount of said linear esters is at least 99 wt. % relative to the weight of the dry matter content. In a further preferred embodiment, the dry matter content of said aqueous linear ester dispersion consists essentially of:
79.0-99.9 wt. % linear esters;
optionally up to 10 wt. % vegetable oil;
0.1 to 10.0 wt. % surfactant; and
Up to 1.0 wt. % residuals and impurities.

In another preferred embodiment, the dry matter content of said aqueous linear ester dispersion consists essentially of:
89.0-99.9 wt. % linear esters;
Optionally up to 10 wt. % vegetable oil;
0.1 to 10.0 wt. % surfactant; and
Up to 1.0 wt. % residuals and impurities.

In another preferred embodiment, the dry matter content of said aqueous linear ester dispersion comprises, preferably consists essentially of:
44-99.9 wt. % linear esters; more preferably 54-99.8 wt. % linear esters;
Optionally up to 40 wt. % vegetable oil, more preferably up to 30 wt. % vegetable oil;
0.1 to 15.0 wt. % surfactant; more preferably 0.1 to 10 wt. % surfactant;
Up to 1.0 wt. % impurities.

These aqueous linear ester dispersions show a great optimum between shear stability, barrier properties with respect to water and water vapor and ecological considerations.

The linear esters as referred to herein as preferably chosen from the list of: linear monoesters according to formula (I), linear di-esters according to formula (II), linear di-esters according to formula (III), or mixtures thereof, as described above.

In a preferred embodiment of the invention, the ester dispersion has a viscosity of at most 2000 mPa·s, preferably of at most 1500 mPa·s, more preferably of at most 1000 mPa·s, even more preferably of at most 500 mPa·s.

A low viscosity is advantageous as the ester dispersion is easily pumpable and thus easier in use.

In a further embodiment of the invention, the ester dispersion has a viscosity of at most 2000 mPa·s, preferably of at most 1500 mPa·s, more preferably of at most 1000 mPa·s, even more preferably of at most 500 mPa·s, for at least 1 month, preferably at least 2 months, more preferably at least 3 months, even more preferably at least 4 months, even more preferably at least 5 months, and with the highest preference at least 6 months at room temperature. The term “room temperature”, as used herein, refers to an ambient temperature of between 2° and 25° C.

In a preferred embodiment of the invention, the ester dispersion has a viscosity of at most 10000 mPa·s, more preferably at most 8000 mPa·s, more preferably at most 6000 mPa·s, more preferably at most 5000 mPa·s, more preferably at most 4000 mPa·s, more preferably at most 3000 mPa·s, more preferably at most 2500 mPa·s, more preferably at most 2000 mPa·s, more preferably of at most 1500 mPa·s, more preferably at most 1000 mPa·s, even more preferably at most 750 mPa·s, more preferably at most 500 mPa·s, more preferably at most 250 mPa·s, more preferably at most 150 mPa·s. In a further preferred embodiment, the ester dispersion has a viscosity between 150 and 10000 mPa·s, more preferably the ester dispersion has a viscosity between 150 and 8000 mPa·s, more preferably the ester dispersion has a viscosity between 150 and 5000 mPa·s. A low viscosity is advantageous as the ester dispersion is easily pumpable and thus easier in use. Very low viscosities are generally obtained by low dry matter content or low ester chain length. For the application of water-impermeable coatings, this tradeoff is no longer desirable below 250 mPa·s.

The term “elevated temperature”, as used herein, refers to an ambient temperature of between 35 and 45° C., preferably about 40° C.

The inventors have unexpectedly found that an ester dispersion in a coating kit according to the invention is stable for long periods of time, at room temperatures as well at elevated temperatures.

High stability of the dispersion is desirable as it provides a higher processability, allowing for improved storage and easier compounding or admixing with further constituents. Stability at elevated temperatures is advantageous as the need for cooled transportation is eliminated. Stability at elevated temperatures is advantageous as the need for cooled transportation is eliminated.

In a preferred embodiment of the invention, the ester dispersion has a median particle size d50 of at most 10 μm, preferably at most 8 μm, more preferably at most 6 μm, even more preferably at most 4 μm, and with the most preference at most 2 μm. Dispersions with smaller particles are more stable with respect to flowing, coagulation and flocculation. Moreover, after drying, dispersions with smaller particles result in a more homogeneous film.

The ester dispersion according to the invention can have any pH between 1 and 12, in a preferred embodiment, the pH of the ester dispersion lies between 2 and 12, more preferably the pH of the ester dispersion lies between 3 and 11, more preferably the pH of the ester dispersion lies between 4 and 10, more preferably the pH of the ester dispersion lies between 5 and 9, more preferably the pH of the ester dispersion lies between 6 and 8, most preferably the pH of the ester dispersion lies between 6 and 7. The inventors have unexpectedly found that the most advantageous coatings are achieved with ester dispersions which are neutral.

In a preferred embodiment, the ester dispersion comprises little to no hydrocarbons (without ester group). In a further preferred embodiment, the ester dispersion comprises at most 25 wt. % of not esterified hydrocarbons, more preferably at most 20 wt. % of not esterified hydrocarbons, more preferably at most 15 wt. % of not esterified hydrocarbons, more preferably at most 10 wt. % of not esterified hydrocarbons, more preferably at most 5 wt. % of not esterified hydrocarbons, more preferably at most 4 wt. % of not esterified hydrocarbons, more preferably at most 3 wt. % of not esterified hydrocarbons, more preferably at most 2 wt. % of not esterified hydrocarbons, more preferably at most 1 wt. % of not esterified hydrocarbons; all wt. % s relative to the dry matter content of the linear ester dispersion. Not esterified hydrocarbons particularly include paraffins, cyclic alkanes, unsaturated alkenes and aromatic compounds. In a particular embodiment, not esterified hydrocarbons include paraffins.

In an embodiment of the invention, the aqueous ester dispersion comprises one or more surfactants.

Any type of surfactant known to the person skilled in the art may be used. A surfactant, also known as “emulgent” or “emulsifier” is a substance that decreases the interfacial tension between two immiscible liquids, such as molten wax and water and thus that stabilizes an emulsion of two or more immiscible liquids by increasing its kinetic stability, that is to say increase the time scale on which the emulsion destabilizes, therefor increasing its shelf life.

Surfactants are surface active agents, which typically have a polar or hydrophilic and non-polar or lipophilic part.

A wide range of surface-active compounds can be used as surfactant. Preferably, the used surfactant will be selected from the group of anionic, cationic, amfoteric or non-ionic surface-active compounds, more preferably the used surfactant will be selected from the group of anionic surface-active compounds, amfoteric compounds, non-ionic surface-active compounds, or mixtures thereof. The term mixtures hereby comprises both physical mixtures of anionic and non-ionic surface-active molecules as well as molecules in which both anionic and polar non-ionic groups are present (electrosteric stabilization). In an even more preferred embodiment of the invention, the one or more surfactant is chosen from the list of: non-ionic surfactant, or a combination of non-ionic surfactant and anionic surfactant, comprising both mixtures of these types of surfactants as well as surfactants which contain both types of groups.

Suitable surfactants may also include solid particles such as colloidal silica, such stabilization is defined as ‘Pickering stabilization’.

Anionic surface-active compounds comprise saponified fatty acids, saponified rosin acid derivatives and derivatives of fatty acids without carboxylic groups such as sodium dodecylsulphate (SDS), sodium dodecyl benzene sulphonate, sulphates and sulphonates.

A carboxylate is a compound which comprises at least one carboxylate group in the molecule. Examples of carboxylates are:
soaps, such as stearates, oleates, cocoates of alkaline metals or of ammonium, alkanolamines
ether carboxylates, such as Akypo® RO20, Akypo® RO50, Akypo® RO90
polymers containing saponified carboxylate groups comprising styrene-maleic anhydride resins such as Xiran® 1000H, Xiran® 2000H, Xiran® 3000H, Xiran® 1000HNa, Xiran® 2000 HNa, Xiran® 3000 HNa
Carboxymethylcellulose

A sulphonate is a compound, that comprises at least one sulphonate group in the molecule. Examples of sulphonates are:
Alkyl benzene sulphonates, such as Lutensit® A-LBS, Lutensit® A-LBN, Lutensit® A-LBA, Marlon® AS3, Maranil® DBX, Disponil® LDBS 25
Alkyl naphtalene sulphonates condensed with formaldehyde, lignine sulphonates, such as e.g. Borresperse NA, Tamol NH7519
Alkyl sulphonates, such as Alscoap OS-14P, BIO-TERGE® AS-40, BIO-TERGE® AS-40 CG, BIO-TERGER AS-90 Beads, Calimulse® AOS-20, Calimulse® AOS-40, Calsoft® AOS-40, Colonial® AOS-40, Elfan® OS 46, Ifrapon® AOS 38, Ifrapon® AOS 38 P, Jeenate® AOS-40, Nikkol® OS-14, Norfox® ALPHA XL, POLYSTEP® A-18, Rhodacal® A-246L, Rhodacal® LSS-40/A
Sulphonated oil, such as Turkish red oil
Olefin sulphonates
Aromatic sulphonates, such as Nekal®BX, Dowfax® 2A1

A sulphate is a compound that comprises at least one SO₄-group in the molecule. Examples of sulphates are:
Fatty alcohol sulphates, such as Disponil® ALS-IS, Disponil® EHS 47, Disponil® SDS 15, Disponil® SDS G, Disponil® SLS 101 Special, Disponil® OCS 27, Dispersogen®SI, Elfan® 280, Mackol® 100N
Other alcohol sulphates, such as Emal® 71, Lanette® E
Coco fatty alcohol ether sulphates, such as EMAL® 20C, Latemul® E150, Sulfochem® ES-7, Texapon® ASV-70 Spec., Agnique SLES-229-F, Octosol 828, POLYSTEP® B-23, Unipol® 125-E, 130-E, Unipol® ES-40
Other alcohol ether sulphates, such as Avanel® S-150, Avanel® S 150 CG, Avanel® S150 CG N, Witcolate® D51-51, Witcolate® D51-53.

A phosphate is a compound that comprises at least one PO₄-group in the molecule. Examples of phosphates are:
Alkyl ether phosphates, such as Maphos® 37P, Maphos® 54P, Maphos® 37T, Maphos® 210T, Maphos® 210P
Phosphates such as Lutensit A-EP
Alkyl phosphates

Examples of surface active compounds which can stabilize dispersions electrosterically, thus containing both an anionic and a non-ionic hydrophilic part are fatty alcohol ether sulfates such as Disponil® FES and Disponil® BES type products. But such compounds can also be polymeric for example proteins such as caseinates, soy protein isolate, whey protein isolate, pectins from different sources . . . .

Cationic surface-active compounds comprise dialkyl benzene alkyl ammonium chloride, alkyl benzyl methyl ammonium chloride, alkyl benzyl dimethyl ammonium bromide, benzalkonium chloride, cetyl pyridinium bromide, C₁₂, C₁₅, or C₁₇ trimethyl ammonium bromides, halide salts of quaternary polyoxy-ethylalkylamines, dodecyl benzyl triethyl ammonium chloride and benzalkonium chloride.

Cationic surface-active compounds comprise also polymeric types such as modified -cationic- starch and chitosan.

Examples of cationic surfactants are also: quaternary ammonium compounds. A quaternary ammonium compound is a compound, that comprises at least one R₄N⁺-group in the molecule. Examples of counter ions that can be used in quaternary ammonium compounds are:
Halogen, methosulphates, sulphates and carbonates of coco fat or cetyl/oleyl trimethyl ammonium.

Preferably, the following cationic surfactants are used:
N—C16-18-alkyl-(even-numbered, C18 unsaturated) propane-1,3-diamine salts
N,N-dimethyl-N-(hydroxy-C₇-C₂₅-alkyl) ammonium salts
Mono- and di(C₇-C₂₅-alkyl)dimethyl ammonium compounds
Ester quats, especially mono-, di- and trialkanol amines, quaternary ammonium compounds esterificated with C₈-C₂₂ carboxylic acids.
Imidazolin quats, especially 1-alkylimidazolinium salts.

Examples of surface active compounds which can stabilize dispersions electrosterically, thus containing both a cationic and a non-ionic hydrophillic part comprise saponified derivates of ethoxylated fatty amines such as Genamin® O 020 special, Genamin® S 100, Genamin® S 200

An amphoteric surfactant is a compound that, under conditions of use, comprises at least one positive charge and at least one negative charge. Betain surfactants are an example of this type. An alkyl betain is a betain surfactant that comprises at least one alkyl unit per molecule. Examples of betain surfactants are:
Cocamidopropylbetain, such as MAFO® CAB, Amonyl® 280BE, Amphosol® CA, Amphosol® CG, Amphosol® CR, Amphosol® HCG, Amphosol® HCG-50, Chembetaine® C, Chembetaine® CGF, Chembetaine® CL, Dehyton® PK, Dehyton® PK 45, Emery® 6744, Empigen® BS/F, Empigen® BS/FA, Empigen® BS/P, Genagen® CAB, Lonzaine® C, Lonzaine® CO, Mirataine® BET-C-30, Mirataine® CB, Monateric® CAB, Naxaine® C, Naxaine® CO, Norfox® CAPB, Norfox® Coco Betaine, Ralufon® 414, TEGO®-Betain CKD, TEGO® Betain E KE 1, TEGO®-Betain F, TEGO®-Betain F 50, and aminoxides such as alkyl dimethylamineoxide.

Also lecithin can be considered as an amphoteric surfactant because the biggest fraction of the phospholipids in lecithin comprise at least one positive charge and at least one negative charge under conditions of use.

Non-ionic surfactant comprise polyvinyl alcohol, ethylene vinyl alcohol, block copolymers of polyethylene oxide and polypropylene oxide, poly-acrylic acid, methylcellulose, ethylcellulose, propylcellulose, hydroxyethylcellulose, carboxymethylcellulose, natural gum, polyoxyethylene cetyl ether, polyoxyethylene lauryl ether, polyoxyethylene octyl ether, polyoxyethylene octylphenyl ether, polyoxyethylene oleyl ether, (ethoxylated) sorbitan comprising esters polyoxyethylene sorbitan monolaurate, polyoxyethylene sorbitan mono-oleate, polyoxyethylene sorbitan mono-stearate, sorbitan monolaurate, sorbitan mono-oleate, sorbitan mono-steate, polyoxyethylene stearyl ether, polyoxyethylene nonylphenyl ether and dialkylphenoxy poly(ethyleneoxy) ethanol.

Non-ionic surfactant have a neutral, polar and hydrophilic head that makes non-ionic surfactant water-soluble. Such surfactants adsorb at surfaces and aggregate to micelles above their critical micelle concentration. Different surfactants can be identified depending on the type of hydrophilic head, such as (oligo)oxyalkylene groups, and especially (oligo)oxyethylene groups, (polyethylene)glycol groups, (poly)glycerol groups and carbohydrate groups, such as alkyl polyglucosides, sucrose-esters and fatty acid N-methyl glucamides.

Alcohol phenolalkoxylates are compounds that can be produced through addition of alkylene oxide, preferably ethylene oxide, to alkyl phenols. Non-limiting examples are: Norfox® OP-102, Surfonic® OP-120, T-Det® 0-12.

Another example of non-ionic surfactants are fatty acid ethoxylates which are fatty acids that are treated with different amounts of ethylene oxide or reacted with polyethyleneglycol chains of varying chain lengths. Non-ionic surfactants can also be obtained by reacting polyglycerol molecules with said fatty acids.

Fatty acid alcohol amides comprise at least one amide group with an alkyl group and one or two alkoxyl groups. Alkyl polyglycosides are mixtures of alkyl monoglucosides (alkyl-α-D- and -β-D-glucopyranoside with a small amount-glucofuranoside), alkyl diglucosides (-isomaltosides, -maltosides and others) and alkyloligoglucosides (-maltotriosides, -tetraosides and others).

Non-ionic surfactants comprise also molecules obtained from triglyceride sources. For example ethoxylated castor oil of ethoxylated hydrogenated castor oil as well as polyethoxylated mono- and/or diglycerides.

Alkyl polyglycosides can non-limiting be synthesized with an acid catalyzed reaction (Fischer reaction) of glucose (or starch) or n-butylglycosides with fatty alcohols. Further, also alkyl polyglycosides can be used as non-ionic surfactant. A non-limiting example is Lutensol® GD70. In addition, also non-ionic N-alkylated, preferably N-methylated, fatty amides can be used as surfactant.

Alcohol alkoxylates comprise a hydrophobic part with a chain length of 4 to 20 carbon atoms, preferably 6 to 19 C-atoms and more preferably 8 to 18 C-atoms, whereby the alcohol can be linear or branched, and a hydrophilic part that comprises alkoxylate units, such as ethylene oxide, propylene oxide and/or butylene oxide, with 2 to 80 repeating units. Non-limiting examples are: Lutensol® XP, Lutensol® XL, Lutensol® ON, Lutensol® AT, Lutensol® A, Lutensol® AO, Lutensol® TO.

In a preferred embodiment of the invention, the ester dispersion comprises the one or more surfactants, in a total amount of at most 40 wt. %, more preferably at most 35 wt. %, more preferably at most 30 wt. %, more preferably at most 25 wt. %, more preferably at most 20% by weight, preferably at most 15% by weight, more preferably at most 10% by weight, even more preferably at most 9% by weight, more preferably at most 8% by weight, more preferably at most 7% by weight, more preferably at most 6% by weight, more preferably at most 5% by weight, more preferably at most 4% by weight, more preferably at most 3% by weight, more preferably at most 2% by weight, more preferably at most 1.5% by weight, more preferably at most 1.0% by weight, more preferably at most 0.8% by weight, more preferably at most 0.6% by weight, more preferably at most 0.5% by weight, more preferably at most 0.4% by weight, more preferably at most 0.3% by weight, more preferably at most 0.2% by weight, more preferably at most 0.1% by weight relative to the weight of the aqueous ester dispersion. In another or further preferred embodiment of the invention, the ester dispersion comprises the one or more surfactants, in a ratio by weight of the total amount of linear esters to the total amount of surfactants is at least 3, more preferably at least 4, more preferably at least 5, more preferably at least 6, more preferably at least 7, more preferably at least 8, more preferably at least 9, more preferably at least 10. A low amount of surfactant in the ester dispersion is advantageous due to the lower amount of hydrophilic parts. The lower the amount of surfactant, the higher the hydrophobicity of the resulting coating, and thus the higher the water impermeability of the resulting coating.

In a preferred embodiment of the invention, the ester dispersion comprises the one or more surfactants, in a total amount of at most 25 wt. %, more preferably at most 20% by weight, preferably at most 15% by weight, more preferably at most 10% by weight, even more preferably at most 9% by weight, more preferably at most 8% by weight, more preferably at most 7% by weight, more preferably at most 6% by weight, more preferably at most 5% by weight, more preferably at most 4% by weight, more preferably at most 3% by weight, more preferably at most 2% by weight, more preferably at most 1.5% by weight, more preferably at most 1.0% by weight, more preferably at most 0.8% by weight, more preferably at most 0.6% by weight, more preferably at most 0.5% by weight, more preferably at most 0.4% by weight, more preferably at most 0.3% by weight, more preferably at most 0.2% by weight, more preferably at most 0.1% by weight relative to the weight of the dry matter content of the aqueous ester dispersion. In another or further preferred embodiment of the invention, the ester dispersion comprises the one or more surfactants, in a ratio by weight of the total amount of linear esters to the total amount of surfactants is at least 5, preferably at least 10. A low amount of surfactant in the ester dispersion is advantageous due to the lower amount of hydrophilic parts. The lower the amount of surfactant, the higher the hydrophobicity of the resulting coating, and thus the higher the water impermeability of the resulting coating.

In a preferred embodiment, the total amount of said linear esters is at least 15 wt. % relative to the weight of the aqueous linear ester dispersion, more preferably the total amount of said linear esters is at least 20 wt. % relative to the weight of the aqueous linear ester dispersion, more preferably the total amount of said linear esters is at least 25 wt. % relative to the weight of the aqueous linear ester dispersion, more preferably the total amount of said linear esters is at least 30 wt. % relative to the weight of the aqueous linear ester dispersion, more preferably the total amount of said linear esters is at least 35 wt. % relative to the weight of the aqueous linear ester dispersion, more preferably the total amount of said linear esters is at least 40 wt. % relative to the weight of the aqueous linear ester dispersion, more preferably the total amount of said linear esters is at least 45 wt. % relative to the weight of the aqueous linear ester dispersion, most preferably the total amount of said linear esters is at least 50 wt. % relative to the weight of the aqueous linear ester dispersion; and the aqueous ester dispersion comprises the one or more surfactants, in a total amount of at most 25 wt. %, more preferably at most 20% by weight, preferably at most 15% by weight, more preferably at most 10% by weight. The dispersion with this combination of a high ester content and relatively low surfactant content have a very large impact on barrier properties for water and water vapor, even in relatively low concentrations. Increasing the surfactant concentration and/or reducing the linear ester content results in easier production and formulation of ester emulsions, but has negative effects on the barrier properties.

In a further preferred embodiment, the ester dispersion comprises the one or more surfactants, wherein the ratio by weight of the total amount of linear esters to the total amount of surfactants is at least 3, more preferably at least 4, more preferably at least 5, more preferably at least 6, more preferably at least 7, more preferably at least 8, more preferably at least 9, more preferably at least 10, more preferably at least 11, more preferably at least 12, more preferably at least 13, more preferably at least 14, more preferably at least 15, more preferably at least 20. In a further preferred embodiment, wherein the ratio by weight of the total amount of linear esters to the total amount of surfactants is between 3 and 20, more preferably between 4 and 15, more preferably between 5 and 15, most preferably between 8 and 15. The applicant found these ratios of ester to emulsifier to result in a good balance between stability of the dispersion and impermeability of the resulting coating to water and water vapor.

In one embodiment of the invention, the ester dispersion further comprises one or more additives, such as anti-foaming agents or fillers.

The aqueous ester dispersion according to the present invention, can be prepared by emulsifying a wax composition comprising esters, preferably linear esters such as described above, in water. In some embodiments of the invention, this is achieved by addition of emulsifiers, also described as surfactants, as described above, to the dispersion.

Any surfactant well known in the art of food contact coatings, can be used in preparing the packaging materials. In certain embodiments, the emulsifier is food contact grade. More preferably, an edible emulsifier selected. In some embodiments, the emulsifier enables the wax composition to be in a liquid form at room temperature. The emulsifier may facilitate the formation of a dispersion.

Said wax composition can be obtained by providing one or more free fatty acids, providing one or more primary aliphatic alcohols, such as fatty alcohols, optionally providing one or more diols, and optionally providing one or more dicarboxylic acids; and reacting the one or more free fatty acids with the one or more fatty alcohols, optionally with the one or more diols, and optionally with the one or more dicarboxylic acids. Preferably in the presence of an esterification catalyst at a temperature of 60° C. to 120° C., to form one or more linear monoester or diester compounds; and removing the esterification catalyst from the formed linear monoester or diester compounds. Said wax composition is preferably obtained by reacting one or more C2-24 free fatty acids, preferably C12-18 free fatty acids, with one or more C2-24 fatty alcohols, preferably C12-18 fatty alcohols.

In a preferred embodiment, the linear ester wax wherein said linear ester wax has a melting point between 35 and 120° C., preferably said linear ester wax has a melting point between 4° and 95° C., more preferably said linear ester wax has a melting point between 4° and 90° C., more preferably said linear ester wax has a melting point between 4° and 80° C., more preferably said linear ester wax has a melting point between 4° and 70° C., more preferably said linear ester wax has a melting point between 50 and 70° C., more preferably said linear ester wax has a melting point between 5° and 65° C., most preferably said linear ester wax has a melting point between 55 and 65° C. Waxes with these melting points can be emulsified in water at atmospheric pressures. Lower melting points allow for improved film-forming and reduced coating brittleness but lead to more difficult processability of the coated substrate by increasing the odds of blocking (sticking together of adjacent coated sheets).

In another embodiment, the linear ester wax wherein said linear ester wax has a melting point between 10° and 400° C., more preferably said linear ester wax has a melting point between 10° and 350° C., more preferably said linear ester wax has a melting point between 10° and 300° C., more preferably said linear ester wax has a melting point between 10° and 250° C., more preferably said linear ester wax has a melting point between 12° and 250° C., more preferably said linear ester wax has a melting point between 15° and 250° C. Waxes with such a high melting point are more difficult to be processed, but allow the packaging to be suitable for heating such as ovens. High melting points can be achieved by using an excess of fatty acid to fatty alcohol, thus obtaining a wax with a higher acid value. In a further preferred embodiment, high melting points can be achieved by using linear esters according to formula III, a part of said esters having hydrogen on the R8 position.

The melting point and properties of the wax are influenced by the molecular weight and the molecular weight distribution of the esters in the wax composition. The inventors have found that a broader molecular weight distribution improves the emulsification thereof, reducing the need for high shear, high temperatures and high amounts of surfactants. The molecular weight distribution of the wax dispersion can be measured as the dispersity or heterogeneity index as commonly used for polymer samples. The dispersity is defined as the ratio of the weight-average molecular weight to the number-average molecular weight of the wax. In a preferred embodiment, the dispersity or heterogeneity index as commonly used for polymer samples is higher than 1. In other words, the wax is not uniform. In a further preferred embodiment, the dispersity of the of the linear ester wax is at least 1.0001, more preferably the dispersity is at least 1.0005, more preferably the dispersity is at least 1.0010, more preferably the dispersity is at least 1.0050, more preferably the dispersity is at least 1.010, more preferably the dispersity is at least 1.020, more preferably the dispersity is at least 1.025, more preferably the dispersity is at least 1.03, more preferably the dispersity is at least 1.035, more preferably the dispersity is at least 1.04, more preferably the dispersity is at least 1.05, more preferably the dispersity is at least 1.06, more preferably the dispersity is at least 1.07, more preferably the dispersity is at least 1.08, more preferably the dispersity is at least 1.09, more preferably the dispersity is at least 1.10, more preferably the dispersity is at least 1.15, more preferably the dispersity is at least 1.20, more preferably the dispersity is at least 1.25. In a preferred embodiment, the dispersity is at most 1.5, more preferably the dispersity is at most 1.4, more preferably the dispersity is at most 1.3.

The esterification reaction is preferably carried out in the presence of an esterification catalyst. In principle, any acidic, nonvolatile esterification catalyst can be used in the esterification reaction. Typically, the esterification catalyst is solid acidic catalyst, such as a strong acidic ion exchange resin containing the residues of strong acids in their free form bound to a polymer matrix. As recognized by those skilled in the art, ion exchange resins of the type are commercially available from a variety of sources in various forms, e.g., as small beads, and under various names, for instance, an Amberlyst® 15 catalyst. Preferably, the esterification catalyst is present in a concentration ranging from 0.1 to 10 wt % of the total reactants, for instance, from 0.5 to 5 wt % of the total reactants, or from 2 to 5 wt % of the total reactants.

The emulsions comprising linear wax esters can be prepared in any way known to the person skilled in the art. These methods comprise rotor-stator systems, ultrasonic homogenization, membrane emulsification, high-pressure homogenization as well as low-energy systems such as inversion. More preferably the method can be easily used on an industrial scale, such as rotor-stator and high-pressure homogenization. Most preferably, high-pressure homogenization is used. More preferably the primary homogenization pressure is at least 20 bar. Advantageously, the resulting particle size is very small.

In a preferred embodiment, the linear ester wax has an iodine adsorption value of at most 100 g I2/100 g linear ester wax, preferably at most 75 g I2/100 g linear ester wax, preferably at most 50 g I2/100 g linear ester wax, preferably at most 40 g I2/100 g linear ester wax, preferably at most 30 g I2/100 g linear ester wax, preferably at most 25 g I2/100 g linear ester wax, preferably at most 20 g I2/100 g linear ester wax, preferably at most 15 g I2/100 g linear ester wax, preferably at most 10 g I2/100 g linear ester wax, preferably at most 7.5 g I2/100 g linear ester wax, preferably at most 5.0 g I2/100 g linear ester wax, preferably at most 4.0 g I2/100 g linear ester wax, preferably at most 3.0 g I2/100 g linear ester wax, preferably at most 2.0 g I2/100 g linear ester wax, preferably at most 1.0 g I2/100 g linear ester wax, preferably at most 0.8 g I2/100 g linear ester wax, preferably at most 0.5 g I2/100 g linear ester wax, preferably at most 0.3 g I2/100 g linear ester wax. The iodine adsorption value is preferably measured in accordance with ISO 3961:2018. A higher iodine number gives less crystalline and thus more emulsifiable waxes but also increases susceptibility to oxidation. A higher iodine number further lowers the melting point of the wax.

In a preferred embodiment, the linear ester wax has an acid value of at most 50 mg KOH/g linear ester wax, preferably at most 40 mg KOH/g linear ester wax, preferably at most 30 mg KOH/g linear ester wax, preferably at most 20 mg KOH/g linear ester wax, preferably at most 15 mg KOH/g linear ester wax, preferably at most 10 mg KOH/g linear ester wax, preferably at most 7.5 mg KOH/g linear ester wax, preferably at most 5.0 mg KOH/g linear ester wax, preferably at most 4.0 mg KOH/g linear ester wax, preferably at most 3.0 mg KOH/g linear ester wax, preferably at most 2.0 mg KOH/g linear ester wax, preferably at most 1.0 mg KOH/g linear ester wax, preferably at most 0.8 mg KOH/g linear ester wax, preferably at most 0.5 mg KOH/g linear ester wax, preferably at most 0.3 mg KOH/g linear ester wax. The acid value is preferably measured in accordance with ASTM D664. A lower acid value implies a lower amount of residual (fatty) acids in the wax. In a further preferred embodiment, both the acid and hydroxyl values are kept low, more preferably below the limits for each species defined above. The term “acid number” or “acid value” as used herein refers to a number used to quantify the acidity of a given chemical substance. It is the quantity of base, expressed in milligrams of potassium hydroxide (KOH), that is required to neutralize the acidic constituents in 1 gram of sample. This is related to the residual fatty acid and fatty alcohol content or thus the purity of the ester. The term “hydroxyl number” or “hydroxyl value” as used herein refers to the number of milligrams of potassium hydroxide (KOH) required to neutralize the acetic acid taken up on acetylation of one gram of a chemical substance that contains free hydroxyl groups. This is related to the residual fatty acid and fatty alcohol content or thus the purity of the ester and can be measured by techniques known by the person skilled in the art.

In a preferred embodiment, the linear ester wax is a lightly coloured wax. This is particularly advantageous for the application of the resulting linear ester wax dispersion as coating onto a substrate. Dark waxes lead to dark coatings, which are generally undesirable in particular by consumers in food-based products. In a preferred embodiment, the linear ester wax has a Lovibond 5¼″ yellow value of at most 20, more preferably a yellow value of at most 15, more preferably a yellow value of at most 10, more preferably a yellow value of at most 5, more preferably a yellow value of at most 4, more preferably a yellow value of at most 3, more preferably a yellow value of at most 2, most preferably a yellow value of at most 1.

In a preferred embodiment, the linear ester wax has a Lovibond 5¼″ red value of at most 5, more preferably a red value of at most 4, more preferably a red value of at most 3, more preferably a red value of at most 2, more preferably a red value of at most 1, most preferably lower than 1. In a particularly preferred embodiment, the linear ester wax has a Lovibond 5¼″ yellow value of at most 20 and a red value of at most 3, more preferably a yellow value of at most 10 and a red value of at most 1. The Lovibond colour is preferably measured in accordance with ISO 15305.

The inventors have unexpectedly found that a coating kit according to the present invention results in light colored paper coatings, which is advantageous as the coating should not be too dark.

Binders which can be used in combination with the inventive dispersion of linear ester waxes generally comprise waterborne dispersions—often described as latex or lattices (plural)—, solutions of water soluble polymers as well as waterborne reactive binder systems.

In a preferred embodiment, suitable waterborne binder dispersions are chosen from the list of dispersions of following polymers: acrylic acid copolymers such as styrene acrylates and vinyl acetate acrylates, styrene butadiene copolymers, polyurethane dispersions, acetate copolymers such as polyvinyl acetate, ethylene vinyl acetate and vinyl acetate ethylene dispersions as well as polyesters such as poly lactic acid, polyhydroxyalkanoate, polybutylene succinate, polybutylene adipate terephthalate and natural latex dispersions.

The diameter of the latex particles of said binder is preferably lower than 5 μm, preferably lower than 3 μm, more preferably lower than 1 μm, more preferably lower than 0.5 μm, most preferably lower than 0.3 μm. The solids content of the binder latex is preferably at least 10% by weight of the binder latex, preferably at least 20%, more preferably at least 30%, more preferably at least 40%, most preferably at least 50%. The binder latex may also contain additives, preferably foam control agents and/or biocide. Such latices also have the advantage of being supplied in a ready-to-use form and can be stored without fear of microbiological breakdown.

In a preferred embodiment, binder latices are used in conjunction with a co-binder. Suitable co-binders are chosen from the list comprising: (modified) starch and PVOH. Co-binders, although having a lower binding power, are able to control the rheological characteristics of the coating mix.

Characteristics of latices that are important to their selection for a particular application are their glass transition temperature, which affects the physical nature (flexibility) of the latex, their minimum film formation temperature, their interfacial energy, which is important in relation to the wetting of and adhesion to the base paper and to the printability of the coated paper their particle size distribution with smaller particles generally improving binding power, but also increasing latex viscosity. The film formation temperature of the latex is critical. In a preferred embodiment, the lattice has a glass transition temperature of at most 70° C., more preferably at most 60° C., more preferably at most 50° C., more preferably at most 40° C.

In a preferred embodiment, the binder is a water soluble polymer. In a further preferred embodiment, the binder is a water soluble polymer binder based on natural polymers. More preferably, the binder is a water soluble polymer binder based on a natural polymer chosen from the list of: polysaccharides, including (modified) starches, (modified) alginate, (modified) cellulose such as carboxymethylcellulose and hydroxypropylmethylcellulose, chitosan but also proteins such as caseinates, soy protein isolate, whey protein isolate. Natural polymers can more easily be bio-based in large volumes, which is desirable for ecological reasons. In another preferred embodiment, the binder is a water soluble polymer binder based on synthetic polymers chosen from the list of: polyvinylalcohol and ethylene vinylalcohol.

In another preferred embodiment, waterborne reactive binder systems can be used. In a further preferred embodiment, said waterborne reactive binder systems are based on polymers chosen from the list of: phenol-formaldehyde resins, ureum-formaldehyde resins, melamin ureum formaldehyde, lignin based and isocyanate based systems.

In a preferred embodiment of the invention, the one or more binder is a polymeric binder. Suitable polymeric binders are binders that are customary in papermaking. Our investigations, however, have shown that a suitable selection of the binder may significantly improve the mechanical properties of the barrier layer and/or the biodegradability of the barrier paper. Our investigations have shown that it is advantageous and therefore preferred in accordance with the invention if the polymeric binder is a crosslinked or noncrosslinked binder selected from the list of: starch, polyvinyl alcohol, carboxyl group-modified polyvinyl alcohol, ethylene-vinyl alcohol copolymer, a combination of polyvinyl alcohol and ethylene-vinyl alcohol copolymer, ethylene-vinyl acetate copolymer, silanol group-modified polyvinyl alcohol, diacetone-modified polyvinyl alcohol, modified polyethylene glycol, unmodified polyethylene glycol, α-isodecyl-ω-hydroxy-poly(oxy-1,2-ethanediyl), styrene-butadiene latex, styrene-acrylate polymers, acrylic copolymers, and mixtures thereof.

In a particular preferred embodiment, the binder is chosen from a styrene-acrylate binder, a polyacrylate binder or a styrene-butadiene binder. These binders have excellent coating properties and great compatibility with the linear ester emulsions described in present application. The inclusion of a relatively small amount of esters, such 10/90 dry/dry, results in a very significant improvement in barrier properties.

Our own investigations have revealed that the coating kit of the invention has particularly high resistance to fat, oil, and moisture if the polymeric binder is one or more styrene-acrylate polymers or the binder comprises the latter.

Of the binders stated above, ethylene-vinyl alcohol copolymer and polyvinyl alcohol are the least preferred. Particular preference is therefore given to coating kits, which do not comprise ethylene-vinyl alcohol copolymer and/or polyvinyl alcohol.

In the context of the present invention, a polymeric binder is understood to mean a binder which has been synthesized by polycondensation from a multitude of molecules, and in which one or more kinds of atoms or atomic moieties (called repeat units) are strung together repeatedly, with the number of repeat units per molecule being more than 25.

It is preferred in accordance with one aspect of the invention if the coating kit comprises no ethylene.

The dry/dry ratio between two dispersions is the ratio by weight of the dry matter content of each respective dispersion. In a preferred embodiment, the dry/dry weight ratio of the aqueous linear ester dispersion to the binders is at most 50/50 dry/dry, more preferably at most 45/55 dry/dry, more preferably at most 40/60 dry/dry, more preferably at most 35/65 dry/dry, more preferably at most 30/70 dry/dry, more preferably at most 25/75 dry/dry, more preferably at most 20/80 dry/dry, more preferably at most 15/85 dry/dry, more preferably at most 10/90 dry/dry, more preferably at most 5/95 dry/dry. The inventors found that linear ester dispersions have a very pronounced effect on the barrier properties, particularly barrier to water and water vapor, even at relatively low dry/dry ratios. This is particularly interesting when using aqueous linear ester dispersions with a high linear ester content and a relatively low surfactant or emulsifier content. In other words, the addition low amounts of linear ester dispersion to the coating composition can drastically improve the barrier to water vapor.

In an aspect, the invention relates to the use of the coating kit according to the present invention for coating food packaging, preferably paper food packaging.

The coating kit is especially advantageous for closed paper packaging, because in paper food packaging it is generally necessary that next to the barrier to liquid water, the barrier to water vapor is also increased by the coating. The inventors unexpectedly found that a very big decrease in water vapor transmission rate was achieved in paper food packaging coated with a coating kit according to the invention, as opposed to coatings comprising branched ester structures, such as triglyceride esters.

However, it is obvious that the invention is not limited to this application. The advantageous effects described above are also present when the coating kit is used to coat other surfaces.

In an aspect, the invention relates to the use of the coating kit according to the present invention for coating cellulose surfaces, preferably paper, cardboard, molded pulp, molded fiber, fiberboard, wood, particle board, chipboard, oriented strand board, wood, and so forth.

In an aspect, the invention relates to the use of the dispersion according to the present invention to impart hydrophobicity to other formulations and products.

In an aspect, the invention relates to the use of the dispersion according to the present invention to provide hydrophobicity, water repellency or water-resistance to any phase of a composite material; in particular the bulk phase of fiber-based. In a particular embodiment, the dispersions may be used to impose water-resisting and/or insulating, in particular vapor insulating, properties to composite materials. In a further preferred embodiment, such composites are cellulose based. In particular, suitable composites include particleboard, chipboard, oriented strand board, molded fiber, molded pulp and cardboard.

In another aspect, the present invention relates to a coating composition. In a preferred embodiment of the invention, the coating composition is suitable for coating cellulose surfaces, preferably paper, cardboard, or wood. In an even more preferred embodiment of the invention, the coating composition is suitable for coating cellulose surfaces in food packaging.

In a preferred embodiment of the invention, the coating composition is an aqueous coating composition. In a further preferred embodiment, the composition comprises one or more esters and one or more binders. Said binder being a waterborne binder as described above.

In a preferred embodiment of the invention, the coating composition is an aqueous composition comprising one or more linear esters. Preferably, said linear esters are chosen from the list of: linear monoesters, linear di-esters, or mixtures thereof. Said linear esters are preferably chosen from the list of: linear monoesters according to formula (I), linear di-esters according to formula (II), linear di-esters according to formula (III), or mixtures thereof.

In a preferred embodiment of the invention, said coating composition comprises said linear esters in an amount of at least 1% by weight, preferably of at least 1.5% by weight, more preferably of at least 2% by weight, more preferably of at least 2.5% by weight, even more preferably of at least 3% by weight, more preferably of at least 3.5% by weight, even more preferably of at least 4.0% by weight, even more preferably of at least 4.5% by weight, even more preferably of at least 5.0% by weight.

In a preferred embodiment of the invention, said coating composition comprises said linear esters in an amount of 1-50% by weight, more preferably 1 to 50% by weight, more preferably 1 to 45% by weight, more preferably 1 to 40% by weight, more preferably 1 to 35% by weight, more preferably 1 to 30% by weight, more preferably 1 to 25% by weight, more preferably 1 to 20% by weight, more preferably 1 to 19% by weight, more preferably 1 to 18% by weight, more preferably 1 to 17% by weight, more preferably 1 to 16% by weight, more preferably 1 to 15% by weight, more preferably 2 to 15% by weight, more preferably 3 to 15% by weight, more preferably 4 to 15% by weight, more preferably 5 to 15% by weight.

A high ester content of the coating composition results in an increased water impermeability in the resulting coating, the water impermeability being valid for both liquid as vapor. A high ester content is also advantageous because it gives flexibility to the coating composition, as dilution of the composition in terms of the intended application is very easily achieved.

A particular advantage of coatings containing linear esters according to the present invention have a significantly lower gas transmission rate than coatings containing wax triglycerides. In a preferred embodiment, the coatings have a coating thickness less than 500 μm, more preferably less than 250 μm, more preferably less than 100 μm, more preferably less than 80 μm, more preferably less than 60 μm, more preferably less than 50 μm, more preferably less than 40 μm, more preferably less than 30 μm. In a preferred embodiment, the coatings have a coating thickness of at least 0.5 μm, more preferably at least 1.0 μm, more preferably at least 1.5 μm, more preferably at least 2.0 μm, more preferably at least 2.5 μm, most preferably at least 3 μm.

In a preferred embodiment, the water vapor transmission rate is at most 300 g per m² per 24 hours, more preferably the water vapor transmission rate is at most 250 g per m² per 24 hours, more preferably the water vapor transmission rate is at most 200 g per m² per 24 hours, more preferably the water vapor transmission rate is at most 150 g per m² per 24 hours, more preferably the water vapor transmission rate is at most 100 g per m² per 24 hours, more preferably the water vapor transmission rate is at most 75 g per m² per 24 hours, more preferably the water vapor transmission rate is at most 50 g per m² per 24 hours, more preferably the water vapor transmission rate is at most 40 g per m² per 24 hours, more preferably the water vapor transmission rate is at most 30 g per m² per 24 hours, more preferably the water vapor transmission rate is at most 25 g per m² per 24 hours, more preferably the water vapor transmission rate is at most 20 g per m² per 24 hours, more preferably the water vapor transmission rate is at most 15 g per m² per 24 hours, more preferably the water vapor transmission rate is at most 10 g per m² per 24 hours, more preferably the water vapor transmission rate is at most 5 g per m² per 24 hours, more preferably the water vapor transmission rate is at most 3 g per m² per 24 hours, more preferably the water vapor transmission rate is at most 1 g per m² per 24 hours. In a preferred embodiment, the water vapor transmission rate is measured according to TAPPI T464. The water vapor transmission rate is preferably measured at a coating thickness of 25 μm.

In a preferred embodiment, the oxygen transmission rate is at most 20 moles per m² per 24 hours, more preferably the oxygen transmission rate is at most 18 moles per m² per 24 hours, more preferably the oxygen transmission rate is at most 16 moles per m² per 24 hours, more preferably the oxygen transmission rate is at most 14 moles per m² per 24 hours, more preferably the oxygen transmission rate is at most 12 moles per m² per 24 hours, more preferably the oxygen transmission rate is at most 10 moles per m² per 24 hours, more preferably the oxygen transmission rate is at most 8 moles per m² per 24 hours, more preferably the oxygen transmission rate is at most 6 moles per m² per 24 hours, more preferably the oxygen transmission rate is at most 5 moles m² per 24 hours, more preferably the oxygen transmission rate is at most 4 moles per m² per 24 hours, more preferably the oxygen transmission rate is at most 3 moles per m² per 24 hours, more preferably the oxygen transmission rate is at most 2 moles per m² per 24 hours, more preferably the oxygen transmission rate is at most 1 mole per m² per 24 hours, more preferably the oxygen transmission rate is at most 0.5 mole per m² per 24 hours. In a preferred embodiment, the oxygen transmission rate is measured according to ASTM D1434-82. The water vapor transmission rate is preferably measured at a coating thickness of 25 μm.

In a preferred embodiment, the carbon dioxide transmission rate is at most 20 moles per m² per 24 hours, more preferably the carbon dioxide transmission rate is at most 18 moles per m² per 24 hours, more preferably the carbon dioxide transmission rate is at most 16 moles per m² per 24 hours, more preferably the carbon dioxide transmission rate is at most 14 moles per m² per 24 hours, more preferably the carbon dioxide transmission rate is at most 12 moles per m² per 24 hours, more preferably the carbon dioxide transmission rate is at most 10 moles per m² per 24 hours, more preferably the carbon dioxide transmission rate is at most 8 moles per m² per 24 hours, more preferably the carbon dioxide transmission rate is at most 6 moles per m² per 24 hours, more preferably the carbon dioxide transmission rate is at most 5 moles m² per 24 hours, more preferably the carbon dioxide transmission rate is at most 4 moles per m² per 24 hours, more preferably the carbon dioxide transmission rate is at most 3 moles per m² per 24 hours, more preferably the carbon dioxide transmission rate is at most 2 moles per m² per 24 hours, more preferably the carbon dioxide transmission rate is at most 1 mole per m² per 24 hours, more preferably the carbon dioxide transmission rate is at most 0.5 mole per m² per 24 hours. In a preferred embodiment, the carbon dioxide transmission rate is measured according to ASTM D1434-82. The water vapor transmission rate is preferably measured at a coating thickness of 25 μm.

In another preferred embodiment, the gas transmission rate for air, nitrogen and noble gasses is limited.

In a preferred embodiment of the invention, said coating composition comprises said one or more binders in a total amount of binders of 70-99% by weight, more preferably of 75-99% by weight, more preferably of 80-99% by weight, even more preferably of 85-99% by weight, even more preferably 90-99% by weight.

The inventors have unexpectedly found that a coating composition according to the present invention results in light colored paper coatings, which is advantageous as the coating should not be too dark.

The coating composition according to the present invention, can be prepared by compounding the ester dispersion, as described above, with the one or more binders. In some embodiments of the invention, additional emulsifiers, as described above, can be added to the composition.

The coating composition can be applied to a variety of surfaces with techniques as known in the art. Any method for coating a packaging material which results in wax-coated material having a finite size and shape using a film to surround the substrate is in general suitable. For example, curtain coating, drop casting, dip coating, optical deposition, spray coating, flexo and semi-flexo coating, gravure coating, knife or blade coating, compression or press coating and layer-by-layer deposition are known and suitable techniques.

A wide variety of substrates (such as packaging substrates), well known in the art of package making, can be used in preparing the coated materials. For instance, a paper, a cardboard, or a thermoplastic polymer composition.

In an aspect, the invention relates to the use of the coating composition according to the present invention for coating food packaging, preferably paper food packaging.

The coating composition is especially advantageous for closed paper packaging, because in paper food packaging it is generally necessary that next to the barrier to liquid water, the barrier to water vapor is also lowered by the coating. The inventors unexpectedly found that a very big decrease in water vapor transmission rate was achieved in paper food packaging coated with a coating composition according to the invention, as opposed to coatings comprising branched ester structures, such as triglyceride esters.

However, it is obvious that the invention is not limited to this application. The advantageous effects described above are also present when the coating composition is used to coat other surfaces.

In an aspect, the invention relates to the use of the coating composition according to the present invention for coating cellulose surfaces, preferably paper, cardboard, or wood.

The invention is further described by the following non-limiting examples which further illustrate the invention, and are not intended to, nor should they be interpreted to, limit the scope of the invention.

The present invention will be now described in more details, referring to examples that are not limitative.

### EXAMPLES

The present invention will now be further exemplified with reference to the following examples. The present invention is in no way limited to the given examples or to the embodiments presented in the figures.

### Comparative Examples 1-3 & Example 4

The water vapor transmission rate (WVTR) was tested for a coating of styrene-acrylate (Joncryl ECO 2117) as such (comparative example 1) or in combination with a fully hydrogenated triglyceride (Impermax B48-P) (comparative example 2), paraffin wax (Impermax WRP 50F2) (comparative example 3) or stearylstearate (example 4). The ratio of wax to binder was 10/90 dry/dry. To better exemplify reference is made to table 1, which show(s) the WVRT in g/m2/24 h for these four coating compositions. WVRT was determined in accordance with TAPPI T464 at 38° C. and 90% RH.

TABLE 1
Comparative examples 1-3 & example 4

| | C. Ex 1 | C. Ex 2 | C. Ex 3 | Ex 4 |
|---|---|---|---|---|
| Water vapor | 273 | 199 | 24 | 35 |
| transmission rate | | | | |
| (g/m²/24 h) | | | | |

These results show that dispersions of linear monoesters according to formula (I), in combination with a binder, resulted in a coating with similar paper barrier properties as paraffin based wax dispersions, also in terms of water vapor permeability. However, this ingredient is biobased, biodegradable, there is no risk of contamination with MOSH/MOAH and a paper coated with this ester is easier to repulp.

### Comparative Examples 5-6 & Example 7

Both the water uptake (%) as all as the swelling (%) of chip board treated with ureum formaldehyde binder as such (comparative example 5) or this binder in combination with a fully hydrogenated triglyceride (Impermax B58) (comparative example 6) or stearylstearate (example 7) was tested according to European method EN 317. The ratio of wax to binder was 6/94 dry/dry. To better exemplify reference is made to FIG. 2, which shows the water uptake in % for different soaking times in water and FIG. 3 which shows the degree of swelling (%) for different soaking times in water.

These results show that the emulsion of linear monoesters according to formula (I) obtained lower water uptake and swelling values as compared to the emulsion of fully hydrogenated triglyceride. Moreover, in this case the same emulsifier system was used for both waxes. But, in fact, much more possibilities in terms of emulsifier selection are available when linear monoesters need to be emulsified.

Comparative examples 8-10 and examples 11-13 Table 2 discloses example ester emulsions according to the present invention in % by weight of the emulsion. Viscosity is given in mPa·s.

TABLE 2
comparative examples 8-10 and examples 11-13

| | Com | Com | Com | | | |
|---|---|---|---|---|---|---|
| | Ex 8 | Ex 9 | Ex 10 | Ex 11 | Ex 12 | Ex 13 |
| Agri-Pure ™ AP- | 35 | 45.9 | 37.4 | | | |
| 660 | | | | | | |
| stearyl stearate | | | | 35 | 45.9 | 37.4 |
| Refined rapeseed | | | 8.5 | | | 8.5 |
| oil | | | | | | |
| Softened water | 61.2 | 50 | 50 | 61.2 | 50 | 50 |
| Emulan ® EL | 3.5 | | | 3.5 | | |
| Radiasurf ®7145 | | 2 | 2 | | 2 | 2 |
| Radiasurf ®7147 | | 2 | 2 | | 2 | 2 |
| Preventol ® BIT | 0.3 | | | 0.3 | | |
| 10 | | | | | | |
| Acticide ® LA | | 0.1 | 0.1 | | 0.1 | 0.1 |
| Viscosity | NA | NA | NA | 53 | 65 | 75 |
| (Sp2, 100 rpm) | | | | | | |
| Dry matter | NA | NA | NA | 38.5 | 50 | 50 |
| content | | | | | | |
| pH | NA | NA | NA | 6.8 | 6.7 | 6.9 |

The dispersions were produced by mixing the molten wax phase at +−80° C. with the preheated water phase at +−80° C., by which a pre-emulsion was created. The droplet size of the emulsion droplets was further reduced by passing the pre-emulsion 3 times through a high-pressure homogenizer operating at a pressure of 180 and 20 bar. After the last pass, the emulsion was cooled quickly to 20-30° C. using a heat-exchanger.

Emulsions from fully hydrogenated triglyceride oils, such as fully hydrogenated rapeseed oil (Agri-Pure™ AP-660) are much more difficult to stabilize than those from linear esters according to the invention. The composition of comparative examples 8-10 were not stable (thickened within hours or days of storage at room temperature) whereas the corresponding compositions of example 11-13, containing linear esters according to the invention, were stable for 6 months at 20° C. (no increase in viscosity above 2000 mPa·s) as well as stable to shear (no destabilization after 300 gram of the samples was sheared for 60 seconds with an IKA® T50 Ultraturrax equipped with G45M dispersion element running at 3000 rpm). These compositions were also stable when stored for 6 months at 40° C. (which means their viscosity does not increase to more than 2000 mPa·s). Moreover, they show broad compatibility in mixtures, such as the combination with latices (styrene butadiene, styrene acrylate).

### Examples 14-20: The Effect of a Vegetable Oil

A series of stearyl stearate dispersions with varying amounts of vegetable oil were produced.

The dispersions were produced by mixing the molten wax phase with the preheated water phase at 70° C., by which a pre-emulsion was created. The pre-emulsion was passed 3 times through a high-pressure homogenizer, operating at a pressure of 180 and 20 bar. After the last pass through the high-pressure homogenizer, the emulsion was cooled quickly to 20-30° C. using a heat-exchanger.

Preventol BIT10 and Mergal K9N were included as preservatives. Polysorbate 60 was utilized as surfactant or emulsifier. The % oil is the amount of vegetable oil relative to the dry matter content of the emulsion.

| | Ex. | Ex. | Ex. | Ex. | Ex. | Ex. | C. Ex. |
|---|---|---|---|---|---|---|---|
| | 14 | 15 | 16 | 17 | 18 | 19 | 20 |
| | Vegetable oil content (%) | | | | | | |
| | 0% | 5% | 10% | 20% | 40% | 80% | 100% |
| | Oil | Oil | Oil | Oil | Oil | Oil | Oil |
| Refined Rapeseed | | 2.295 | 4.59 | 9.18 | 18.36 | 36.72 | 45.9 |
| oil | | | | | | | |
| Stearyl Stearate | 45.9 | 43.605 | 41.31 | 36.72 | 27.54 | 9.18 | 0 |
| Polysorbate 60 | 4 | 4 | 4 | 4 | 4 | 4 | 4 |
| Soft water | 49.66 | 49.66 | 49.66 | 49.66 | 49.66 | 49.66 | 49.66 |
| Preventol BIT10 | 0.35 | 0.35 | 0.35 | 0.35 | 0.35 | 0.35 | 0.35 |
| Mergal K9N | 0.09 | 0.09 | 0.09 | 0.09 | 0.09 | 0.09 | 0.09 |

The viscosity was measured with a Brookfield spindle 2 at 100 rpm. The time before destabilization under shear was measured on an Ultraturrax at 3000 rpm. The congealing point is the congealing point of the starting wax, comprising both the stearyl stearate and the refined rapeseed oil combination, prior to emulsification.

| | Ex. 14 | Ex. 15 | Ex. 16 | Ex. 17 | Ex. 18 | Ex. 19 | C. Ex. 20 |
|---|---|---|---|---|---|---|---|
| | Vegetable oil content (%) | | | | | | |
| | 0% | 5% | 10% | 20% | 40% | 80% | 100% |
| | Oil | Oil | Oil | Oil | Oil | Oil | Oil |
| pH | 7.31 | 7.34 | 7.27 | 7.04 | 7.55 | 7.95 | 8.46 |
| d10 (μm) | 0.169 | 0.078 | 0.18 | 0.182 | 0.2 | 0.209 | 0.214 |
| d50 (μm) | 0.275 | 0.244 | 0.334 | 0.349 | 0.354 | 0.366 | 0.382 |
| d90 (μm) | 0.587 | 0.423 | 0.543 | 0.57 | 0.626 | 0.621 | 0.643 |
| Viscosity mPa · s) | 90.8 | 76.8 | 75.6 | 62.8 | 60.4 | 61.6 | 65.2 |
| Destabilization time | 10.5 | 14 | 20.75 | 40 | 30.75 | 8 | 60 |
| under shear (min) | | | | | | | |
| Wax Congealing | 57 | 57 | 56 | 55 | 54 | | |
| point(° C.) | | | | | | | |

The emulsions were included in coatings applied to ChromoCard HB GC1 Consumer board paper of 300 gsm. The coatings consisted of 10% wax and 90% binder, dry/dry. The binder was a commercial styrene-acrylate binder. Identical coating procedures were followed: coatings were applied with a wet thickness of 24 μm using a bar coater running at 9 m/min. After application, the coatings were dried at 80° C. for 5 minutes in a convection oven. The water vapor transmission rate (WVTR) was determined in accordance with TAPPI T464 at 38° C. and 90% RH. The water resistance was determined using the COBB-test, in which a contact time of 1800 seconds was used (COBB1800) in accordance with TAPPI T411. All coating experiments were performed in triplicate and values averaged.

| | Ex. | Ex. | Ex. | Ex. | Ex. | Ex. | C. Ex. |
|---|---|---|---|---|---|---|---|
| | 14 | 15 | 16 | 17 | 18 | 19 | 20 |
| | Vegetable oil content (%) | | | | | | |
| | 0% | 5% | 10% | 20% | 40% | 80% | 100% |
| | Oil | Oil | Oil | Oil | Oil | Oil | Oil |
| COBB1800 | 1.08 | 1.50 | 1.04 | 1.15 | 1.35 | 1.68 | 7.18 |
| (g/m²) | | | | | | | |
| WVTR | 55 | 54 | 48 | 44 | 47 | 143 | 584 |
| (g/m²/day) | | | | | | | |

The addition of a vegetable oil had a significant effect on the properties of the dispersions containing linear wax esters, particularly their shear stability. An optimum in stability was found around 20% vegetable oil relative to the dry matter content of the emulsion.

### Examples 21-26: The Effect of Surfactant Concentration

A series of stearyl stearate dispersions with varying amounts of surfactant were produced. The compositions of the emulsions was varied in examples 21 to 26. 60 was utilized as emulsifier. The % emulsifier reports the amount of polysorbate 60 by weight, relative to the dry matter content of the emulsion.

The dispersions were produced by mixing the molten wax phase with the preheated water phase at 80° C., by which a pre-emulsion was created. The pre-emulsion was passed 3 times through a high-pressure homogenizer, operating at a pressure of 180 and 20 bar. After the last pass through the high-pressure homogenizer, the emulsion was cooled quickly to 20-30° C. using a heat-exchanger. Preventol BIT10 and Mergal K9N were included as preservatives.

| | Ex. 21 | Ex. 22 | Ex. 23 | Ex. 24 | Ex. 25 | Ex. 26 |
|---|---|---|---|---|---|---|
| | Emulsifier content (%) | | | | | |
| | 5% | 8% | 15% | 20% | 25% | 30% |
| | emul- | emul- | emul- | emul- | Emul- | Emul- |
| | sifier | sifier | sifier | sifier | sifier | sifier |
| Refined | 9.48 | 9.18 | 8.483 | 7.984 | 7.485 | 6.986 |
| rapeseed | | | | | | |
| oil | | | | | | |
| Stearyl | 37.92 | 36.72 | 33.932 | 31.936 | 29.94 | 27.944 |
| Stearate | | | | | | |
| Polysorbate | 2.5 | 4 | 7.485 | 9.98 | 12.475 | 14.97 |
| 60 | | | | | | |
| Soft water | 49.66 | 49.66 | 49.66 | 49.66 | 49.66 | 49.66 |
| Preventol | 0.35 | 0.35 | 0.35 | 0.35 | 0.35 | 0.35 |
| BIT10 | | | | | | |
| Mergal | 0.09 | 0.09 | 0.09 | 0.09 | 0.09 | 0.09 |
| K9N | | | | | | |

The properties of the resulting emulsions was measured. The viscosity was measured with a Brookfield spindle 2 at 100 rpm, and with a Brookfield spindle 3 at 100 rpm. The time before destabilization under shear was measured on an Ultraturrax at 3000 rpm.

| | Ex. 21 | Ex. 22 | Ex. 23 | Ex. 24 | Ex. 25 | Ex. 26 |
|---|---|---|---|---|---|---|
| Emulsifier content (%) | 5% | 8% | 15% | 20% | 25% | 30% |
| pH | 7.56 | 7.58 | 7.11 | 7.23 | 7.04 | 6.98 |
| d10 (μm) | 0.226 | 0.194 | 0.125 | 0.123 | 0.118 | 0.104 |
| d50 (μm) | 0.391 | 0.323 | 0.237 | 0.232 | 0.226 | 0.202 |
| d90 (μm) | 0.652 | 0.503 | 0.418 | 0.408 | 0.404 | 0.376 |
| Droge stof (%) | 51.93 | 50.83 | 51.95 | 51.80 | 50.84 | 51.14 |
| Viscosity (Brookfield spindle | 71.17 | 74.37 | 96.76 | 108.8 | 312.7 | Too |
| 2) (mPa · s) | | | | | | high |
| Viscosity (Brookfield spindle | 60.98 | 65.97 | 85.97 | 95.96 | 309.9 | 617.8 |
| 3) (mPa · s) | | | | | | |
| Time before destabilization | 11 min | 33 min | >120 min | >120 min | >120 min | >120 min |
| under shear (min) | 6 sec | 30 sec | | | | |

The ester emulsions of example 21-26 were included in a series of coatings. Three different coatings were tested, varying the ester to binder content and binder latex.

The emulsions were included in coatings applied to ChromoCard HB GC1 Consumer board paper of 300 gsm. The coating procedures as well as the test protocols were identical to those reported for examples 14-20. Again, all coating experiments were performed in triplicate and values averaged.

Examples 27-32 consisted of coatings of 10% wax and 90% binder, dry/dry. The binder was a commercial styrene-butadiene latex.

| | Coating example | | | | | |
|---|---|---|---|---|---|---|
| | Ex. | Ex. | Ex. | Ex. | Ex. | Ex. |
| | 27 | 28 | 29 | 30 | 31 | 32 |
| Included ester emulsion | Ex. | Ex. | Ex. | Ex. | Ex. | Ex. |
| | 21 | 22 | 23 | 24 | 25 | 26 |
| COBB1800 (g/m2) | 0.82 | 0.94 | 0.91 | 0.69 | 1.66 | 0.82 |
| WVTR (g/m2/day) | 57 | 63 | 65 | 58 | 83 | 121 |

Examples 33-38 consisted of coatings of 40% wax and 60% binder, dry/dry. The binder was the same commercial styrene-butadiene latex as for examples 27-32.

| | Coating example | | | | | |
|---|---|---|---|---|---|---|
| | Ex. | Ex. | Ex. | Ex. | Ex. | Ex. |
| | 33 | 34 | 35 | 36 | 37 | 38 |
| Included ester | Ex. | Ex. | Ex. | Ex. | Ex. | Ex. |
| emulsion | 21 | 22 | 23 | 24 | 25 | 26 |
| COBB1800 | 0.62 | 0.72 | 3.50 | 25.60 | 41.26 | 56.31 |
| (g/m2) | | | | | | |
| WVTR | 87 | 111 | 151 | 209 | 266 | 318 |
| (g/m2/day) | | | | | | |

Examples 39-44 consisted of coatings of 10% wax and 90% binder, dry/dry. The binder was a commercial styrene-acrylate latex.

| | Coating example | | | | | |
|---|---|---|---|---|---|---|
| | Ex. | Ex. | Ex. | Ex. | Ex. | Ex. |
| | 39 | 40 | 41 | 42 | 43 | 44 |
| Included ester | Ex. | Ex. | Ex. | Ex. | Ex. | Ex. |
| emulsion | 21 | 22 | 23 | 24 | 25 | 26 |
| COBB1800 | 1.59 | 2.75 | 3.55 | 3.57 | 4.83 | 6.59 |
| (g/m2) | | | | | | |
| WVTR | 182 | 204 | 282 | 263 | 312 | 314 |
| (g/m2/day) | | | | | | |

Examples 21 to 44 clearly indicate an increase in the emulsifier or surfactant content of the ester emulsion leads to a deterioration of both the water vapor and liquid water barrier of the resulting coating. Therefore, low emulsifier or surfactant content is particularly desirable for hydrophobic ester coatings. This desirable influence on the barrier properties of the resulting coating is a tradeoff with the stability of the emulsion.

### Examples 45-48: High Wax Ester Chain Length

A series of ester dispersions with varying ester wax compositions were produced. The ester wax consisted of a mixture of stearyl stearate wax and rice bran wax. Rice bran is a natural source of wax esters comprising a high amount of linear C48-C64 esters. In examples 45-48, the ratio of stearyl stearate wax to rice bran wax was varied to investigate the effect of increasing the average ester chain length of the wax. The rice bran wax used in these examples was measured to comprise over 93 wt. % of C48 to C64 linear esters. The wax had a congealing point of 82° C.

Polysorbate 60 was utilized as emulsifier. Preventol BIT10 and Mergal K9N were included as preservatives.

| Example | Ex. 45 | Ex. 46 | Ex. 47 | Ex. 48 |
|---|---|---|---|---|
| Stearyl Stearate | | 9.18 | 36.72 | 45.9 |
| Rice Bran Wax | 45.9 | 36.72 | 9.18 | |
| Polysorbate 60 | 4 | 4 | 4 | 4 |
| Soft water | 49.66 | 49.66 | 49.66 | 49.66 |
| Preventol BIT10 | 0.35 | 0.35 | 0.35 | 0.35 |
| Mergal K9N | 0.09 | 0.09 | 0.09 | 0.09 |

The dispersions were produced by mixing the molten wax phase with the preheated water phase at 90° C., by which a pre-emulsion was created. The pre-emulsion was passed 3 times through a high-pressure homogenizer, operating at a pressure of 180 and 20 bar. After the last pass through the high-pressure homogenizer, the emulsion was cooled quickly to 20-30° C. using a heat-exchanger.

The viscosity was measured with a Brookfield spindle 2 at 100 rpm. The time before destabilization under shear was measured on an Ultraturrax at 3000 rpm. The congealing point is the congealing point of the starting wax, comprising both the stearyl stearate and the refined rapeseed oil combination, prior to emulsification.

| Example | Ex. 45 | Ex. 46 | Ex. 47 | Ex. 48 |
|---|---|---|---|---|
| pH | 6.84 | 6.75 | 7.09 | 7.31 |
| Viscosity (mPa · s) | 60.4 | 79.2 | 62 | 90.8 |
| Time before destabilization | 60 | 60 | 60 | 10.5 |
| under shear (minutes) | | | | |

The emulsions were included in coatings applied to ChromoCard HB GC1 Consumer board paper of 300 gsm. The coatings consisted of 10% wax and 90% binder, dry/dry. The binder was a commercial styrene-acrylate binder. Identical coating procedures were followed: coatings were applied with a wet thickness of 24 μm using a bar coater running at 9 m/min. After application, the coatings were dried at 80° C. for 5 minutes in a convection oven. The water vapor transmission rate (WVTR) was determined in accordance with TAPPI T464 at 38° C. and 90% RH. The water resistance was determined using the COBB-test, in which a contact time of 1800 seconds was used (COBB1800) in accordance with TAPPI T411. All coating experiments were performed in triplicate and values averaged.

| Example | Ex. 45 | Ex. 46 | Ex. 47 | Ex. 48 |
|---|---|---|---|---|
| COBB1800 (g/m2) | 2.23 | 1.52 | 1.19 | 1.08 |
| WVTR (g/m2/day) | 105 | 61 | 50 | 55 |

The performance of the coating in terms of water and water vapor resistance was better for examples using a high amount of esters with a chain length between C32 and C36. However, rice bran long chain esters still performed better than non-linear ester waxes, such as hydrogenated oils, in terms of coating barrier properties.

The addition of high melting waxes improves the thermal resistance of the coating. This is beneficial for water resistance at high temperature applications. It is also beneficial when applying coatings at an elevated temperature, for example due to the decreased blocking tendency when the coating is applied.

### Example 49

A linear ester dispersion was created according to ex. 49. The dispersions were produced by mixing the molten wax phase with the preheated water phase at 70° C., by which a pre-emulsion was created. The pre-emulsion was passed 3 times through a high-pressure homogenizer, operating at a pressure of 180 and 20 bar. After the last pass through the high-pressure homogenizer, the emulsion was cooled quickly to 20-30° C. using a heat-exchanger.

| | Ex. 49 |
|---|---|
| Refined rapeseed oil | 2.295 |
| Stearyl Stearate | 43.605 |
| Surfactant | 4 |
| Soft water | 50 |
| Preservative | 0.1 |

The emulsion was included into a series of coatings, to gauge the impact of the inclusion thereof on the permeability of water and water vapor. Coatings were made with pure binder (100% binder) and with the inclusion of the linear ester emulsion of ex. 49, in a 10/90 dry/dry ratio of linear ester to binder. The coatings were applied to ChromoCard HB GC1 Consumer board paper of 300 gsm. The coating procedures as well as the test protocols were identical to those reported for examples 14-20. Again, all coating experiments were performed in triplicate and values averaged.

Joncryl, Exograph and ExoDisp are commercially available styrene-acrylate binders. Exotex, Exopal and HPF are commercially available styrene-butadiene binders. Exobel is a partially biobased styrene-butadiene binder.

| | WVTR (g/m2/24 h) | COBB1800 (g/m2) |
|---|---|---|
| Joncryl ECO 2124E | 457 | 6.8 |
| Joncryl ECO 2124E + Ex. 49 | 88 | 2.4 |
| Joncryl 2118 | 341 | 3.2 |
| Joncryl 2118 + Ex. 49 | 52 | 0.9 |
| Joncryl ECO 2117 | 275 | 3.3 |
| Joncryl ECO 2117 + Ex. 49 | 35 | 0.7 |
| Joncryl 74-E | 321 | 7.5 |
| Joncryl 74-E + Ex. 49 | 63 | 2.0 |
| Exograph 4174 | 740 | 5.4 |
| Exograph 4174 + Ex. 49 | 64 | 1.4 |
| ExoDisp Eco 7360 LE | 674 | 6.3 |
| ExoDisp Eco 7360 LE + Ex. 49 | 169 | 1.3 |
| Exotex 7363 | 294 | 9.8 |
| Exotex 7363 + Ex. 49 | 67 | 3.0 |
| Exopal 7055 | 397 | 29.1 |
| Exopal 7055 + Ex. 49 | 88 | 4.8 |
| Exopal 7045 | 358 | 12.4 |
| Exopal 7045 + Ex. 49 | 79 | 4.6 |
| HPF10 | 358 | 12.4 |
| HPF10 + Ex. 49 | 79 | 4.6 |
| Exobel 2100 | 449 | 46.3 |
| Exobel 2100 + Ex. 49 | 63 | 8.9 |

The results show that the addition of a linear wax ester emulsion according to Ex. 49 reduced the water transmission as well as the water vapor transmission in all examples. The reduction was significant, even at a 10/90 dry/dry ratio. These effects held up for all tested binder compositions.

It is clear that the method according to the invention, and its applications, are not limited to the presented examples.

1. A coating kit, comprising:
an aqueous linear ester dispersion, comprising one or more linear esters in water, wherein said linear esters are chosen from linear monoesters according to formula (I), linear di-esters according to formula (II), linear di-esters according to formula (III), or mixtures thereof, 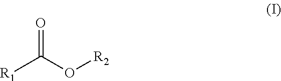
wherein
R1 is chosen from linear C3 to C23 alkyl, and
R2 is independently chosen from linear C4-C24 alkyl, 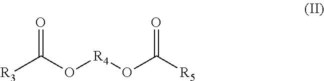
wherein
R3 and R5 are independently of one another chosen from linear C3-C23 alkyl,
R4 is chosen from linear C4-C24 alkanediyl, 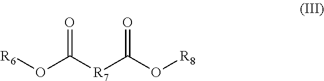
wherein
R6 and R8 are independently of one another chosen from linear C4-C24 alkyl,
R7 is chosen from linear C2-C22 alkanediyl; and
one or more binders, wherein said binder is chosen from a waterborne polymeric binder dispersion, water soluble polymeric binder, waterborne reactive binder or a mixture thereof.

2. The coating kit according to claim 1, wherein said linear esters are linear monoesters according to formula (I): 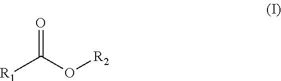
wherein
R1 is chosen from linear C11 to C23 alkyl, and
R2 is independently chosen from linear C12-C24 alkyl.

3. The coating kit according to claim 1, wherein said linear esters are linear di-esters according to formula (II) or (III): 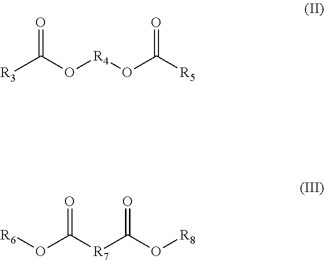
wherein
R3 and R5 are independently of one another chosen from linear C3-C23 alkyl,
R4 is chosen from linear C4-C24 alkanediyl,
R6 and R8 are independently of one another chosen from linear C4-C24 alkyl, and
R7 is chosen from linear C2-C22 alkanediyl.

4. The coating kit according to claim 1, wherein said linear ester dispersion has a dry matter content between 20 and 90% by weight.

5. The coating kit according to claim 1, wherein said linear ester dispersion comprises one or more surfactants, in a total amount of at most 20% by weight, relative to the dry matter content of the aqueous linear ester dispersion.

6. The coating kit according to claim 1, wherein said linear ester dispersion comprises one or more surfactants, and wherein the ratio by weight of the total amount of linear esters to the total amount of surfactants is at least 5.

7. The coating kit according to claim 1, wherein the aqueous linear ester dispersion comprises a vegetable oil in an amount of 3.0 to 30.0% by weight, relative to the dry matter content of the aqueous linear ester dispersion.

8. The coating kit according to claim 1, wherein said linear ester dispersion has a viscosity lower than 2000 mPa·s.

9. The coating kit according to claim 1, wherein said linear ester dispersion has a median particle size d50 of at most 10 μm.

10. The coating kit according to claim 1, wherein the one or more binders are chosen from (modified) starch, (modified) cellulose, polyvinyl alcohol, carboxyl group-modified polyvinyl alcohol, ethylene-vinyl alcohol copolymer, a combination of polyvinyl alcohol and ethylene-vinyl alcohol copolymer, ethylene-vinyl acetate copolymer, silanol group-modified polyvinyl alcohol, diacetone-modified polyvinyl alcohol, modified polyethylene glycol, unmodified polyethylene glycol, α-isodecyl-ω-hydroxy-poly(oxy-1,2-ethanediyl), styrene-butadiene latex, styrene-acrylate polymers, acrylic copolymers, and mixtures thereof.

11. A coating composition, wherein said composition is an aqueous dispersion comprising:
one or more linear esters in water, wherein said linear esters are chosen from linear monoesters according to formula (I), linear di-esters according to formula (II), linear di-esters according to formula (III), or mixtures thereof; 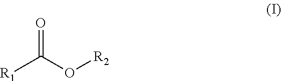
wherein
R1 is independently chosen from linear C3 to C23 alkyl, and
R2 is chosen from linear C4-C24 alkyl, 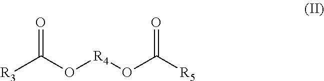
wherein
R3 and R5 are independently of one another chosen from linear C3-C23 alkyl,
R4 is chosen from linear C4-C24 alkanediyl, 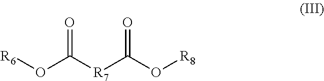
wherein
R6 and R8 are independently of one another chosen from linear C4-C24 alkyl,
R7 is chosen from linear C2-C22 alkanediyl; and
one or more binders, wherein said binder is chosen from a waterborne polymeric binder dispersion, a water soluble polymeric binder, a waterborne reactive binder or a mixture thereof.

12. The coating composition according to claim 11, wherein said coating composition comprises said linear esters in an amount of 1-10% by weight.

13. The coating composition according to claim 11, wherein the coating composition comprises said one or more binders in a total amount of 80-99% by weight.

14. A use of the kit according to claim 1 comprising coating food packaging.

15. A use of the kit according to claim 1 comprising coating cellulose surfaces.

16. A use of the kit according to claim 11 comprising coating food packaging.

17. A use of the kit according to claim 11 comprising coating cellulose surfaces.
